(19) United States
(12) Patent Application Publication
(10) Pub. No.: US 2026/0252824 A1
(43) Pub. Date: Aug. 27, 2026

(54) SYSTEMS AND METHODS FOR SUBSTANTIALLY REAL-TIME SPEECH, TRANSCRIPTION, AND TRANSLATION

(71) Applicant: OneMeta Inc, Bigfork, MT (US)

(72) Inventors: Saul Ignacio Leal, Bountiful, UT (US); Dayanna Verónica Rojas Garcia, Escazú (CR); Melvin Rafael Vega Vega, Sébaco (NI); Jorge Ubaldo Cano, Buenos Aires (AR)

(21) Appl. No.: 19/107,542

(22) PCT Filed: Aug. 31, 2023
(86) PCT No.: PCT/US2023/073256

§ 371 Date: Feb. 27, 2025

Related U.S. Application Data
(60) Provisional application No. 63/374,220, filed on Aug. 31, 2022.
(60) Provisional application No. 63/429,505, filed on Dec. 1, 2022.
(60) Provisional application No. 63/498,261, filed on Apr. 25, 2023.
(60) Provisional application No. 63/499,696, filed on May 2, 2023.
(60) Provisional application No. 63/579,922, filed on Aug. 31, 2023.

(51) Int. Cl. G06F 40/58; G10L 15/30

(52) U.S. Cl. CPC G06F 40/58; G10L 15/30

(57) ABSTRACT

Transcription and translation systems and methods conduct substantially real-time speech-to-text transcription, speech-to-speech translation, and/or speech-to-text translation. The system architecture integrates client devices and third-party services. The system integrates with multiple different third-party transcription and translation services and libraries. The system performs substantially real-time speech-to-text transcription, speech-to-speech translation, and/or speech-to-text translation for meetings, phone calls, and events.

### INCORPORATION BY REFERENCE TO ANY PRIORITY APPLICATIONS

This application claims benefit of: U.S. Provisional Patent Application Ser. No. 63/374,220 titled “SYSTEMS AND METHODS FOR RAPID MULTI-USER TEXT, SPEECH, AND TRANSLATION” filed Aug. 31, 2022; U.S. Provisional Patent Application Ser. No. 63/429,505 with the same title filed Dec. 1, 2022; U.S. Provisional Patent Application Ser. No. 63/498,261 with the same title filed Apr. 25, 2023; U.S. Provisional Patent Application Ser. No. 63/499,696 with the same title filed May 2, 2023; and U.S. Provisional Patent Application Ser. No. 63/579,922 with the same title filed Aug. 31, 2023, the entire contents of which are hereby incorporated for all that they contain, for all purposes.

Any and all applications for which a foreign or domestic priority claim is identified in the Application Data Sheet as filed with the present application are hereby incorporated by reference under 37 CFR 1.57.

### BACKGROUND

Speech-to-text transcription consists of converting spoken words into written words. Speech-to-speech translation consists of translating speech from one language to speech in another language. Speech-to-text translation consists of converting spoken words from one language into written words in another language. Many real-time audio or video streaming platforms do not offer speech-to-text transcription, speech-to-speech translation, or speech-to-text translation. Some video streaming platforms offer automatic speech-to-text transcription services for captioning. However, from the time a video has been uploaded, the automatic speech-to-text transcription processes can take several days to complete. Moreover, the video streaming platforms may not offer automatic translation services. In many cases, automated translation services that are made available to users may require the user to install a software application.

### SUMMARY

The systems, methods, and devices described herein each have several aspects, no single one of which is solely responsible for its desirable attributes. Without limiting the scope of this disclosure, several non-limiting features will now be discussed briefly.

According to some embodiments, a system for substantially real-time speech-to-text, text-to-text, text-to-speech, or speech-to-speech translation for multiple users is disclosed comprising: a data storage medium; and one or more computer hardware processors in communication with the data storage medium, wherein the one or more computer hardware processors are configured to execute computer-executable instructions to at least: implement an application programming interface (API) service configured to receive a language translation request; receive, via the API service, a first translation request from a first client computing device, the first translation request comprising audio data, the audio data comprising speech in a first source language; transmit, via a first third-party API in a first programming language, a first third-party request comprising (i) a first source language indicator associated with the first source language, (ii) a first target language indicator, and (iii) the audio data; receive, from the first third-party API, first text data in a first target language; transmit, to the first client computing device, the first text data in the first target language; receive, via the API service, a second translation request from a second client computing device, the second translation request comprising second text data in a second source language; transmit, via a second third-party API in a second programming language, a second third-party request comprising (i) a second source language indicator associated with the second source language, (ii) a second target language indicator, and (iii) the second text data; receive, from the second third-party API, third text data in a second target language associated with the second target language indicator; and transmit, to the second client computing device, the third text data in the second target language.

In some embodiments, the one or more computer hardware processors may be configured to execute additional computer-executable instructions to at least: determine that the first third-party API is configured to translate the first target language; and select, from a plurality of third-party APIs, the first third-party API based at least in part on the first third-party API being configured to translate the first target language.

In some embodiments, the one or more computer hardware processors may be configured to execute additional computer-executable instructions to at least: determine that another third-party API is unavailable; and select, from among the first third-party API and the another third-party API, the first third-party API based at least in part on the another third-party API being unavailable.

In some embodiments, the one or more computer hardware processors may be configured to execute additional computer-executable instructions to at least: confirm a persistent connection between the API service and the first client computing device, wherein the first translation request is received via the persistent connection; and receive, via the persistent connection, a third translation request from the first client computing device.

In some embodiments, the one or more computer hardware processors may be configured to execute additional computer-executable instructions to at least: implement a protocol buffer between the API service and a processing service; in response to receiving the first translation request, substantially in real-time: determine a command associated with the first translation request; and transmit, via the protocol buffer, the command to the processing service, wherein to transmit the first third-party request is substantially in real-time in response to receiving the first translation request.

In some embodiments, the API service may comprise first computer-executable instructions programmed in a Rust programming language.

According to some embodiments, a system is disclosed comprising: a data storage medium; and one or more computer hardware processors in communication with the data storage medium, wherein the one or more computer hardware processors are configured to execute computer-executable instructions to at least: implement an application programming interface (API) service configured to receive a language translation request; implement a protocol buffer between the API service and a processing service; receive, via the API service, a first translation request from a first client computing device, the first translation request comprising audio data, the audio data comprising speech in a first source language; in response to receiving the first translation request, substantially in real-time: determine a first command associated with the first translation request; transmit, via the protocol buffer, the first command to the processing service; transmit, via a first third-party API, a first third-party request associated with the first command, the first third-party request comprising (i) a first source language indicator associated with the first source language, (ii) a first target language indicator, and (iii) the audio data; receive, from the first third-party API, first text data in a first target language; and transmit, to the first client computing device, the first text data in the first target language.

In some embodiments, the first third-party API can be in a first programming language, and the one or more computer hardware processors may be configured to execute additional computer-executable instructions to at least: receive, via the API service, a second translation request from a second client computing device, the second translation request comprising second text data in a second source language; in response to receiving the second translation request, substantially in real-time: determine a second command associated with the second translation request; transmit, via the protocol buffer, the second command to the processing service; transmit, via a second third-party API in a second programming language, a second third-party request associated with the second command, the second third-party request comprising (i) a second source language indicator associated with the second source language, (ii) a second target language indicator, and (iii) the second text data; receive, from the second third-party API, third text data in a second target language; and transmit, to the second client computing device, the third text data in the second target language.

In some embodiments, the one or more computer hardware processors may be configured to execute additional computer-executable instructions to at least: determine that the first third-party API is configured to translate the first target language; and select, from a plurality of third-party APIs, the first third-party API based at least in part on the first third-party API being configured to translate the first target language.

In some embodiments, wherein to determine that the first third-party API is configured to translate the first target language, the one or more computer hardware processors may be configured to execute additional computer-executable instructions to at least: determine, via a configuration mapping, that the first third-party API supports translation of the first target language.

In some embodiments, the one or more computer hardware processors may be configured to execute additional computer-executable instructions to at least: determine that another third-party API is unavailable; and select, from among the first third-party API and the another third-party API, the first third-party API based at least in part on the another third-party API being unavailable.

In some embodiments, the one or more computer hardware processors may be configured to execute additional computer-executable instructions to at least: determine a first latency associated with the first third-party API at a first region; determine a second latency associated with the first third-party API at a second region; and select, from among the first region and the second region, the first third-party API at the first region based at least in part on the first latency and the second latency, wherein the first third-party request is transmitted to the first third-party API at the first region.

In some embodiments, the one or more computer hardware processors may be configured to execute additional computer-executable instructions to at least: confirm a persistent connection between the API service and the first client computing device, wherein the first translation request is further received via the persistent connection, and wherein the first text data is transmitted via the persistent connection.

According to an embodiment, a method is disclosed comprising: implementing an application programming interface (API) service configured to receive a language translation request; confirming a first persistent connection between the API service and a first client computing device; receiving, via the first persistent connection, a first translation request from the first client computing device, the first translation request comprising first input data associated with a first source language; in response to receiving the first translation request, substantially in real-time: determining a first command associated with the first translation request; transmitting the first command to a processing service; transmitting, via a first third-party API, a first third-party request associated with the first command, the first third-party request comprising (i) a first source language indicator associated with the first source language, (ii) a first target language indicator, and (iii) the first input data; receiving, from the first third-party API, first output data associated with a first target language; and transmitting, via the first persistent connection, the first output data to the first client computing device.

In some embodiments, wherein the first third-party API can be in a first programming language, the method may further comprise: confirming a second persistent connection between the API service and a second client computing device; receiving, via the second persistent connection, a second translation request from the second client computing device, the second translation request comprising second input data associated with a second source language; in response to receiving the second translation request, substantially in real-time: determining a second command associated with the second translation request; transmitting the second command to the processing service; transmitting, via a second third-party API in a second programming language, a second third-party request associated with the second command, the second third-party request comprising (i) a second source language indicator associated with the second source language, (ii) a second target language indicator, and (iii) the second input data; receiving, from the second third-party API, second output data associated with a second target language; and transmitting, via the second persistent connection, the second output data to the second client computing device.

In some embodiments, the method may further comprise: determining that the first third-party API is configured to translate the first target language; and selecting, from a plurality of third-party APIs, the first third-party API based at least in part on the first third-party API being configured to translate the first target language.

In some embodiments, determining that the first third-party API is configured to translate the first target language may further comprise: confirming, via a configuration mapping, that the first third-party API supports translation of the first target language.

In some embodiments, the method may further comprise: implementing a protocol buffer between the API service and a processing service, wherein transmitting the first command to the processing service is via the protocol buffer.

In some embodiments, the method may further comprise: determining that another third-party API is unavailable; and selecting, from among the first third-party API and the another third-party API, the first third-party API based at least in part on the another third-party API being unavailable.

In some embodiments, the method may further comprise: determining a first latency associated with the first third-party API at a first region; determining a second latency associated with the first third-party API at a second region; and selecting, from among the first region and the second region, the first third-party API at the first region based at least in part on the first latency and the second latency, wherein the first third-party request is transmitted to the first third-party API at the first region.

According to an embodiment, a system is disclosed comprising: a data storage medium; and one or more computer hardware processors in communication with the data storage medium, wherein the one or more computer hardware processors are configured to execute computer-executable instructions to at least: implement an application programming interface (API) service configured to receive a language translation request; establish, via a third-party API, a connection with a third-party service; receive, via the API service, a first translation request from a first client computing device, the first translation request comprising audio data, the audio data comprising speech in a first source language; in response to receiving the first translation request, substantially in real-time: determine a first command associated with the first translation request; transmit the first command to a processing service; transmit, via the connection, a first third-party request associated with the first command, the first third-party request comprising (i) a first source language indicator associated with the first source language, (ii) a first target language indicator, and (iii) the audio data; and receive, via the connection, first text data in a first target language; transmit the first text data in the first target language to the first client computing device; receive, via the API service, a second translation request from a second client computing device, the second translation request comprising text data, the text data associated with a second source language; in response to receiving the second translation request, substantially in real-time: determine a second command associated with the second translation request; transmit the second command to the processing service; transmit, via the connection, a second third-party request associated with the second command, the second third-party request comprising (i) a second source language indicator associated with the second source language, (ii) a second target language indicator, and (iii) the text data; receive, via the connection, second text data in a second target language associated with the second target language indicator; and transmit the second text data in the second target language to the second client computing device.

In some embodiments, the processing service may comprise first computer-executable instructions in a Rust programming language.

According to some embodiments, a method is disclosed comprising: implementing a connector configured to receive audio data for translation; confirming a persistent connection between the connector and a telecommunications service; determining a plurality of target language indicators associated with an audio call; receiving, via the persistent connection, first audio data comprising first speech in a first source language from the audio call; transmitting, via a third-party API, a first third-party translation request comprising (i) audio data based on the first audio data and (ii) the plurality of target language indicators; receiving, from the third-party API, first text data in a first target language; transmitting, via the third-party API, a first third-party synthetization request comprising the first text data; receiving, from the third-party API, first output audio data in the first target language; detecting, from the first audio data, a first pause in the first speech that satisfies a threshold time period; transmitting, via a third-party API, a first third-party request comprising (i) audio data based on the first audio data and (ii) the plurality of target language indicators; receiving, from the third-party API, first output audio data in the first target language; and transmitting, via the persistent connection, audio data based on the first output audio data to the telecommunications service.

In some embodiments, the method may further comprise: receiving, via the persistent connection, second audio data comprising second speech in a second source language from the audio call; transmitting, via the third-party API, a second third-party translation request comprising (i) audio data based on the second audio data and (ii) the plurality of target language indicators; receiving, from the third-party API, second text data in a second target language; transmitting, via the third-party API, a second third-party synthetization request comprising the second text data; receiving, from the third-party API, second output audio data in the second target language; detecting, in the second audio data, a second pause in the second speech that satisfies the threshold time period; and transmitting, via the persistent connection, audio data based on the second output audio data to the telecommunications service.

In some embodiments, the first speech can originate from a first speaker, the second speech can originate from a second speaker, the first audio can originate from an audio device, and the second audio can originate from the audio device.

In some embodiments, the method may further comprise: determining a first frequency of the first audio data; and generating the audio data based on the first audio data according to the first frequency.

In some embodiments, the method may further comprise: determining a second frequency of the first output audio data; and generating the audio data based on the first output audio data according to the second frequency.

According to an embodiment, a system is disclosed comprising: a telecommunications server comprising one or more first computer hardware processors; and a processing server comprising one or more second computer hardware processors are configured to execute computer-executable instructions to at least: implement a connector configured to receive audio data for translation; confirm a persistent connection between the connector and the telecommunications server; determine a first language indicator associated with a first caller and a first audio device; determine a second language indicator associated with a second caller and a second audio device; receive, via the persistent connection, first audio data comprising first speech, the first audio data originating from the first audio device; transmit, via a third-party API, a first third-party translation request comprising (i) audio data based on the first audio data, (ii) the first language indicator for a first source language, and (iii) the second language indicator for a first target language; receive, from the third-party API, first text data in the first target language; transmit, via the third-party API, a first third-party synthetization request comprising the first text data; receive, from the third-party API, first output audio data in the first target language; detect, from the first audio data, a first pause in the first speech that satisfies a threshold time period; and transmit, via the persistent connection, audio data based on the first output audio data to the telecommunications server, wherein the one or more first computer hardware processors are configured to execute computer-executable instructions to at least: transmit, to the second audio device, the audio data based on the first output audio data.

In some embodiments, the one or more second computer hardware processors may be configured to execute additional computer-executable instructions to at least: receive, via the persistent connection, second audio data comprising second speech, the second audio data originating from the second audio device; transmit, via the third-party API, a second third-party translation request comprising (i) audio data based on the second audio data, (ii) the second language indicator for a second source language, and (iii) the first language indicator for a second target language; receive, from the third-party API, second text data in the second target language; transmit, via the third-party API, a second third-party synthetization request comprising the second text data; receive, from the third-party API, second output audio data in the second target language; transmit, via the persistent connection, audio data based on the second output audio data to the telecommunications server, wherein the one or more first computer hardware processors are configured to execute computer-executable instructions to at least: transmit, to the first audio device, the audio data based on the second output audio data.

In some embodiments, the one or more second computer hardware processors may be configured to execute additional computer-executable instructions to at least: determine a first frequency of the first audio data; and generate the audio data based on the first audio data according to the first frequency.

In some embodiments, the one or more second computer hardware processors may be configured to execute additional computer-executable instructions to at least: determine a second frequency of the first output audio data; and generate the audio data based on the first output audio data according to the second frequency.

According to an embodiment, a system is disclosed comprising: a telecommunications server comprising one or more first computer hardware processors; and a processing server comprising one or more second computer hardware processors are configured to execute computer-executable instructions to at least: implement a connector configured to receive audio data for translation; confirm a persistent connection between the connector and the telecommunications server; determine a first language indicator associated with a first caller and a first audio device; determine a second language indicator associated with a second caller and a second audio device; receive, via the persistent connection, first audio data comprising first speech, the first audio data originating from the first audio device; transmit, via a third-party API, a first third-party transcription request comprising (i) audio data based on the first audio data and (ii) the first language indicator for a first source language; receive, from the third-party API, first text data in the first source language; transmit, via the third-party API, a first third-party synthetization request comprising (i) the first text data and (ii) the second language indicator for a first target language; receive, from the third-party API, first output audio data in the first target language; detect, from the first audio data, a first pause in the first speech that satisfies a threshold time period; and transmit, via the persistent connection, audio data based on the first output audio data to the telecommunications server, wherein the one or more first computer hardware processors are configured to execute computer-executable instructions to at least: transmit, to the second audio device, the audio data based on the first output audio data.

In some embodiments, the one or more second computer hardware processors may be configured to execute additional computer-executable instructions to at least: receive, via the persistent connection, second audio data comprising second speech, the second audio data originating from the second audio device; transmit, via the third-party API, a second third-party transcription request comprising (i) audio data based on the second audio data and (ii) the second language indicator for a second source language; receive, from the third-party API, second text data in the second source language; transmit, via the third-party API, a second third-party synthetization request comprising (i) the second text data and (ii) the first language indicator for a second target language; receive, from the third-party API, second output audio data in the second target language; transmit, via the persistent connection, audio data based on the second output audio data to the telecommunications server, wherein the one or more first computer hardware processors are configured to execute computer-executable instructions to at least: transmit, to the first audio device, the audio data based on the second output audio data.

In some embodiments, the one or more second computer hardware processors may be configured to execute additional computer-executable instructions to at least: determine a first frequency of the first audio data; and generate the audio data based on the first audio data according to the first frequency.

In some embodiments, the one or more second computer hardware processors may be configured to execute additional computer-executable instructions to at least: determine a second frequency of the first output audio data; and generate the audio data based on the first output audio data according to the second frequency.

According to an embodiment, a method is disclosed comprising: implementing an application programming interface (API) service; confirming a first persistent connection between the API service and an audio/video computing device; confirming a second persistent connection between the API service and a client computing device; receiving, via the second persistent connection, a request to subscribe to a first language channel for an event; determining a first target language indicator associated with the event; receiving, via the persistent connection, first audio data comprising first speech in a first source language from the event; transmitting, via a third-party API, a first third-party translation request comprising (i) audio data based on the first audio data and (ii) the first target language indicator; receiving, from the third-party API, first text data in a first target language; adding the first text data in the first target language to a repository associated with the first language channel; determining that the client computing device is subscribed to the first language channel; and transmitting, via the second persistent connection, the first text data.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above and/or below described embodiments (including one or more aspects of the appended claims).

In various embodiments, computer implemented methods are disclosed in which, by one or more processors executing program instructions, one or more aspects of the above and/or below described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above and/or below described embodiments (including one or more aspects of the appended claims).

### BRIEF DESCRIPTION OF THE DRAWINGS

These and other features, aspects, and advantages are described below with reference to the drawings, which are intended for illustrative purposes and should in no way be interpreted as limiting the scope of the embodiments. Furthermore, various features of different disclosed embodiments can be combined to form additional embodiments, which are part of this disclosure. In the drawings, like reference characters can denote corresponding features throughout similar embodiments. The following is a brief description of each of the drawings.

FIG. 1 is a block diagram depicting an illustrative environment for implementing a transcription and translation system.

FIGS. 2A-2D depict graphical user interfaces of the transcription and translation system.

FIG. 3 is a flow diagram depicting illustrative interactions of a transcription and translation system.

FIGS. 4A-4B are flow charts depicting a method implemented by the transcription and translation system for substantially real-time speech transcription and/or translation.

FIG. 5 is a block diagram depicting another illustrative environment for implementing the transcription and translation system in an audio-to-audio context.

FIGS. 6A-6B depict call management graphical user interfaces of the transcription and translation system.

FIG. 7 depicts another call management graphical user interface of the transcription and translation system.

FIG. 8 is a flow chart depicting a method implemented by the transcription and translation system for substantially real-time speech-to-speech translation.

FIG. 9 is a block diagram depicting another illustrative environment for implementing the transcription and translation system in an event context.

FIGS. 10A-10C depict attendee graphical user interfaces of the transcription and translation system.

FIGS. 11A-11F depict event management graphical user interfaces and user interface elements of the transcription and translation system.

FIG. 12 is a block diagram illustrating an example computing system with which various methods and systems discussed herein may be implemented.

### DETAILED DESCRIPTION

Artificial intelligence speech technology refers to technology that allows computers and software applications to understand speech data. Artificial intelligence speech recognition can use machine learning and/or deep learning. Artificial intelligence speech technology can include automatic speech recognition, which can also be referred to as speech-to-text. Artificial intelligence speech technology can also include text-to-speech where text is converted into a verbal, audio form. Some existing speech-recognition services can receive audio with recorded speech and transcribe the recorded speech, which can also include translating the speech from a first language to a second language. Some existing translation services can receive text and translate the text from a first language to a second language. Some speech-recognition and/or translation services can be faster than others. The latency of the speech-recognition and/or translation services can differ based on a location of the client and a location of available servers for the services. Some speech-recognition and/or translation services can support different languages.

As described above, many audio and/or video platforms do not offer speech-to-text transcription, speech-to-speech translation, or speech-to-text translation. In other systems, to the extent automatic speech-to-text transcription is offered, those processes can take days to complete and even then translation may not be offered. In the case of real-time audio or video platforms and speech-to-text transcription or speech-to-speech/speech-to-text translation, speed can be important. If the systems that enable transcription or translation services are too slow, then such services are of little value to users during a real-time application. Some existing speech services are offered as an Application Programming Interface (API). Different speech services offer support for different functions, such as, but not limited to, support for different human languages, speech-to-speech functionality, etc. Moreover, the existing speech services can be integrated with the computer program instructions of a software application written in a particular computer programming language. However, the functions offered by the APIs can also differ based on the particular programming language used. Existing systems and methods for rapid speech services have deficiencies in speed, consistency, and accessibility. Speech recognition and transcription technology have been developed, but these and related systems and methods suffer from numerous drawbacks.

Generally described, aspects of the present disclosure are directed to improved systems and methods for substantially real-time speech-to-text transcription, speech-to-speech translation, and/or speech-to-text translation. Many existing real-time audio or video platforms do not offer speech-to-text transcription, speech-to-speech translation, or speech-to-text translation; however, the solutions described herein can enable substantially real-time speech-to-text transcription, speech-to-speech translation, and/or speech-to-text translation. The systems and methods described herein can use an efficient programming language for backend and/or middle layer execution, which results in improved speed and performance. The systems and methods described herein can also employ protocol buffers and/or persistent connections for improved speed and performance. Since the improved system can integrate with multiple different third-party transcription and translation services, the improved system can offer many different types of transcription and translation and improved robustness.

With respect to latency and other technical issues, enabling transcription and/or translation functionality in a substantially real-time can be technically challenging. The end result of delays or unavailability of transcriptions/captioning and/or translations/subtitling during a real-time applications can range from inconveniencing some users to making content incomprehensible for other users that rely on transcriptions/captioning and/or translations/subtitling. Accordingly, an improved backend and/or middle layer design with faster programming language(s), buffers, sockets, and/or programming that conserves computing resources can advantageously reduce transcriptions/captioning and/or translations/subtitling latency. Moreover, if the backend is integrated with multiple third-party services, then the system can have improved robustness and performance in the case one or more third-party services are unavailable. As described herein, an improved system design can result in the faster operation of computer processors and, therefore, improvements in the operation of a computer. Improved speed and performance can result from consuming fewer computing resources. As used herein, the term “computing resource” can refer to a physical or virtual component of limited availability within a computer system. Computing resources can include, but are not limited to, computer processors, processor cycles, and/or memory. Moreover, if the improved system is configured to switch to different third-party services during outages, then the system can provide improved robustness and, again, improvements in the operation of a computer.

As used herein, the term “substantially” when used in conjunction with the term “real time” can refer to speeds in which no or little delay occurs perceptible to a user. Substantially in real time can be associated with a threshold latency requirement that can depend on the specific implementation. In some embodiments, latency under or approximately 1 second, 500 milliseconds, 250 milliseconds, or 100 milliseconds can be substantially in real time. In other embodiments, such as audio phone call translations, latency under or approximately 5 seconds, 4 seconds, 3 seconds, 2 seconds, or 1 second can be substantially in real time from a detected pause in speech.

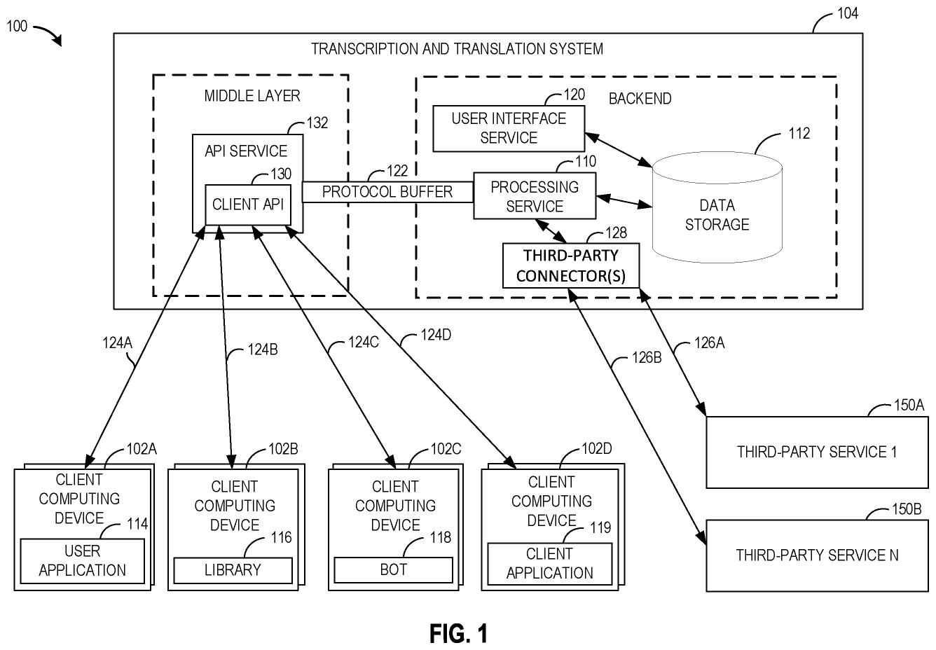

Turning to FIG. 1, an illustrative environment 100 is shown in which a transcription and translation system 104 may facilitate substantially real-time transcriptions and/or translations. The architecture of the transcription and translation system 104 can enable faster speeds than some existing systems, provide services that would otherwise be unavailable, and/or enable the ability to connect multiple third-party services while providing robust features. As described herein, the environment 100 can be in the context of real-time audio or video platforms, such as in the case of a conference, meeting with multiple participants, and/or a phone call. As used herein, “conference” and “meeting” can be used interchangeably. The environment 100 may include one or more client computing devices 102A, 102B, 102C, 102D, one or more third-party services 150A, 150B, and the transcription and translation system 104. The constituents of the environment 100 may be in communication with each other either locally or over one or more networks. The network may be a personal area network, local area network, wide area network, cable network, satellite network, a telephone network, or combination thereof. While certain constituents of the environment 100 are depicted as being in communication with one another, any constituent of the environment 100 can communicate with any other constituent of the environment 100; however, not all of these communication lines are depicted in FIG. 1.

A first client computing device 102A can include, but are not limited to, a laptop or tablet computer, personal computer, personal digital assistant (PDA), hybrid PDA/mobile phone, smart wearable device (such as a smart watch), mobile phone, and/or a smartphone. The first client computing device 102A can execute a user application 114. The one or more other client computing devices 102B, 102C, 102D can include a library 116, a bot 118, and/or a client application 119. The client computing device(s) 102A, 102B, 102C, 102D can communicate with the transcription and translation system 104 via the client application programming interface (API) 130 of the transcription and translation system 104. Each of the user application 114, the library 116, the bot 118, and the client application 119 can invoke functions via the client API 130. As described herein, the functions of the client API 130 can include, but are not limited to, translation and/or transcription functions. The client application 119 can be an application in a video conferencing or Bridge-type audio conferencing system. The library 116 can be a software development kit (SDK) library. Bots 118 can be a custom software module made available in some video conferencing solutions. The user application 114 can be a graphical user interface application executing in the first client computing device 102A.

The transcription and translation system 104 can include a middle layer and a backend. The API service 132 can be a middleware component of the middle layer. A middleware component of the middle layer can communicate with multiple entities in a frontend and/or Internet domain. The API service 132 can receive requests from the client computing device(s) 102A, 102B, 102C, 102D. A middleware component, such as the API service 132, can also communicate with multiple entities in a frontend and/or Internet domain. For example, user computing devices (e.g., user computing devices in a video conferencing or Bridge-type audio conferencing system), libraries (e.g., those using a software development kit or SDK), bots (such as a custom software module made available in some existing video conferencing solutions), and apps (such as application on smartphones and/or tablets) can communicate with the API service 132 (in the middle layer).

The backend of the transcription and translation system 104 can include a processing service 110, a user interface service 120, one or more third-party connectors 128, and a data storage 112. The client API service 132 can communicate with the processing service 110 via a protocol buffer 122. The protocol buffer 122 can be a mechanism for serializing data for transmission. The protocol buffer 122 can be similar to JSON, except that it can be smaller and faster, and can generate native language bindings. The protocol buffer 122 can be a combination of the definition language, the code that a proto compiler generates to interface with data, language-specific runtime libraries, and/or the serialization format for data that is sent across a network connection or written to a file. The protocol buffer 122 can be implemented with Protocol Buffer (also known as Protobuf) from Google®. Accordingly, the protocol buffer 122 can enable fast and efficient communication (using fewer computing resources) between the client API service 132 and the processing service 110.

The API service 132 can be programmed in a programming language, such as, but not limited to Rust. In some embodiments, the programming language (such as Rust) can provide increased performance and speed. The API service 132 can use a JSON Web Token (JWT) approach for security. The API service 132 can use persistent connections (such as WebSockets) and a secure socket layer (SSL). The middleware components, such as the API service 132, can provide security for interacting with the backend processing service 110.

In some embodiments, the API service 132 can create persistent connections 124A, 124B, 124C, 124D with each of the client computing devices 102A, 102B, 102C, 102D. The API service 132 and the client computing devices 102A, 102B, 102C, 102D can communicate via persistent connections that follow a computer communications protocol that provides full-duplex communication channels over a single TCP connection. The persistent connections 124A, 124B, 124C, 124D between the API service 132 and the client computing devices 102A, 102B, 102C, 102D can be implemented with WebSockets. The API service 132 and the client computing devices 102A, 102B, 102C, 102D can communicate over persistent connections that advantageously conserve computing resources (which can result in faster communications) since reusing a persistent connection can result in less connections (such as TCP connections) between the API service 132 and the devices 102A, 102B, 102C, 102D. Therefore, using persistent connections can advantageously avoid additional overhead costs associated with creating and tearing down connections. The API service 132 and the client computing devices 102A, 102B, 102C, 102D can advantageously send messages back and forth over the same persistent connection.

The processing service 110 can process the requests and communicate with the third-party services 150A, 150B. The processing service 110 can be programmed in a programming language, such as, but not limited to Rust. The programming language (such as Rust) of the processing service 110 can advantageously provide increased (such as a 3-fold increase compared to other programming languages) responsiveness and speed as the processing service 110 communicates with other components in the environment 100. The processing service 110 and other components programmed in a particular programming language (such as Rust) can invoke other code instructions (such as those from third parties) that are in other programming languages (such as C# or JavaScript, for example). In some embodiments, such as where the application 114 is a web browser application, the user interface service 120 can provide graphical user interfaces to the web browser application.

The processing service 110 can communicate with the third-party services 150A, 150B with one or more third-party connectors 128. The third-party connector 128 can create a connection 126A, 126B with each of the third-party services 150A, 150B. In some embodiments, the third-party connector 128 is customized for a particular service and/or the library for the third-party connector 128 can be provided by the third-party entity. In some embodiments, the same connection 126A, 126B created by the third-party connector 128 can be reused for multiple different API calls, which can be associated with requests from different client computing devices 102A, 102B, 102C, 102D. In some embodiments, the connections 126A, 126B between the third-party connector 128 and the third-party services 150A, 150B can be persistent connections. Accordingly, the processing service 110 can advantageously conserve computing resources (which can result in faster communications) when communicating with the third-party services 150A, 150B by avoiding creating connections when an existing connection can be reused. The third-party connector(s) 128 and the third-party services 150A, 150B can stream data back and forth.

The third-party services 150A, 150B can perform functions, such as, but not limited to translation and/or transcription functions. The third-party services 150A, 150B that offer translation and/or transcription can include, but are not limited to, Microsoft Azure® Cognitive Services, Google Cloud® Translation AI, and/or Amazon® Translate. A third-party service 150A, 150B can provide the audio and/or video from a meeting. The third-party service 150A, 150B that provides audio and/or video can include, but is not limited to, Vonage®. Each of the third-party services 150A, 150B can provide their own APIs in different programming languages. For a particular third-party service, the functionality provided by the API for a first programming language (such as C#) offered by the service can differ from the functionality provided by the API for a second programming language (such as JavaScript) offered by the service. The backend processing service 110, which can be programmed in a third programming language (such as Rust), can be configured to communicate with the various APIs in different programming languages, which can be offered by the same third-party entity or different third-party entities. In this manner, the backend processing service 110 and the client API 130 (in the middle layer) can allow a client, which may be programmed in a first programming language (such as JavaScript), access to functionality in a second programming language (such as C#) for which the third-party service 150A, 150B would not otherwise make available to a client programmed in the first programming language.

The backend processing service 110 can be configured to make routing decisions among the third-party services 150A, 150B and/or among the nodes of a third-party service 150A, 150B, such as, but not limited to a Point of Presence (PoP), which can be referred to herein as a distribution. In some embodiments, the backend processing service 110 can execute failover logic such that if a first service 150A is unavailable, the backend processing service can switch to a second service 150B. Additionally or alternatively, the backend processing service 110 can execute routing logic to select a first node (such as a first PoP) over a second node (such as a second PoP) if the first node currently has lower latency for a particular client and/or instance of the transcription and translation system 104. The backend processing service 110 can ping the nodes of a third-party service 150A, 150B to determine latency among the nodes. In some embodiments, for particular geographic regions, one or more third-party services 150A may have better performance than other third-party services 150B for a particular region. The backend processing service 110 may store, in the data storage 112, configuration settings that specify the third-party services 150A, 150B that should be used for particular regions. Therefore, in some embodiments, based on the particular region and the configuration settings, the backend processing service 110 can select the appropriate third-party services 150A, 150B for the particular region.

The data storage 112 may be embodied in hard disk drives, solid state memories, or any other type of non-transitory computer-readable storage medium. The data storage 112 may also be distributed or partitioned across multiple local and/or remote storage devices. The data storage 112 may include a data store. As used herein, a “data store” can refer to any data structure (and/or combinations of multiple data structures) for storing and/or organizing data, including, but not limited to, relational databases (e.g., Oracle databases, MySQL databases, etc.), non-relational databases (e.g., NoSQL databases, MongoDB databases, etc.), key-value databases, in-memory databases, tables in a database, and/or any other widely used or proprietary format for data storage. Configuration, such as, but not limited to settings, associated with the client computing devices 102A, 1028, 102C, 102D can be stored in the data storage 112. For example, the source language and/or target language for a profile associated with the 102A, 1028, 102C, 102D can be stored in the data storage 112.

The client computing devices 102A, 102B, 102C, 102D and/or the transcription and translation system 104 may each be embodied in a plurality of devices. Each of the client computing devices 102A, 102B, 102C, 102D and/or the transcription and translation system 104 may include a network interface, memory, hardware processor, and non-transitory computer-readable medium drive, all of which may communicate with each other by way of a communication bus. The network interface may provide connectivity over networks or computer systems. The hardware processor may communicate to and from memory containing program instructions that the hardware processor executes in order to operate the client computing devices 102A, 102B, 102C, 102D and/or the transcription and translation system 104. The memory generally includes RAM, ROM, and/or other persistent and/or auxiliary non-transitory computer-readable storage media.

Additionally, in some embodiments, the transcription and translation system 104 or components thereof (such as the API service 132, the user interface service 120, the processing service 110, and/or the data storage 112) are implemented by one or more virtual machines implemented in a hosted computing environment. The hosted computing environment may include one or more rapidly provisioned and/or released computing resources. The computing resources may include hardware computing, networking and/or storage devices configured with specifically configured computer-executable instructions. A hosted computing environment may also be referred to as a “serverless,” “cloud,” or distributed computing environment.

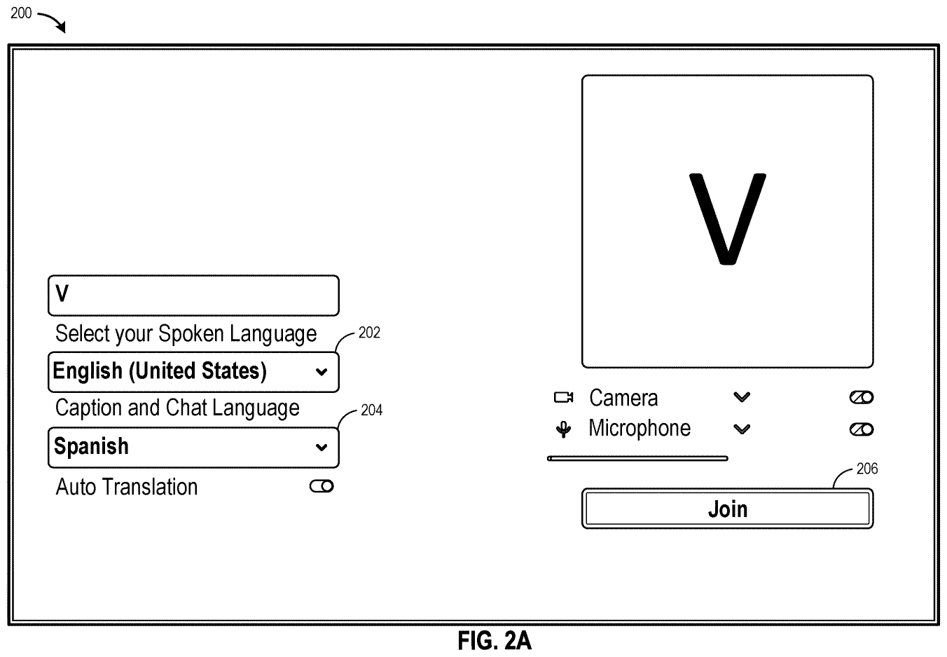

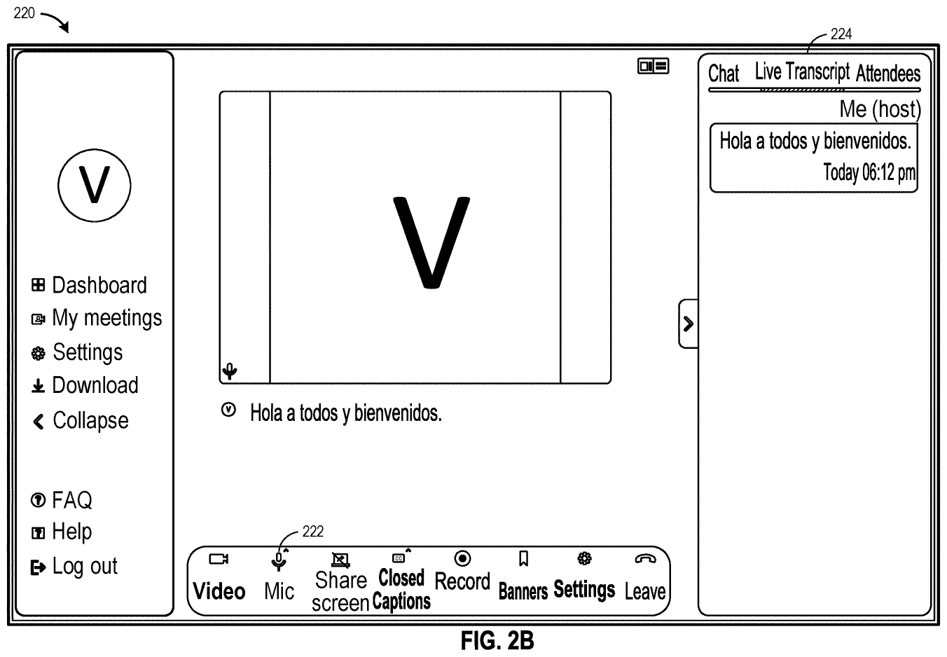

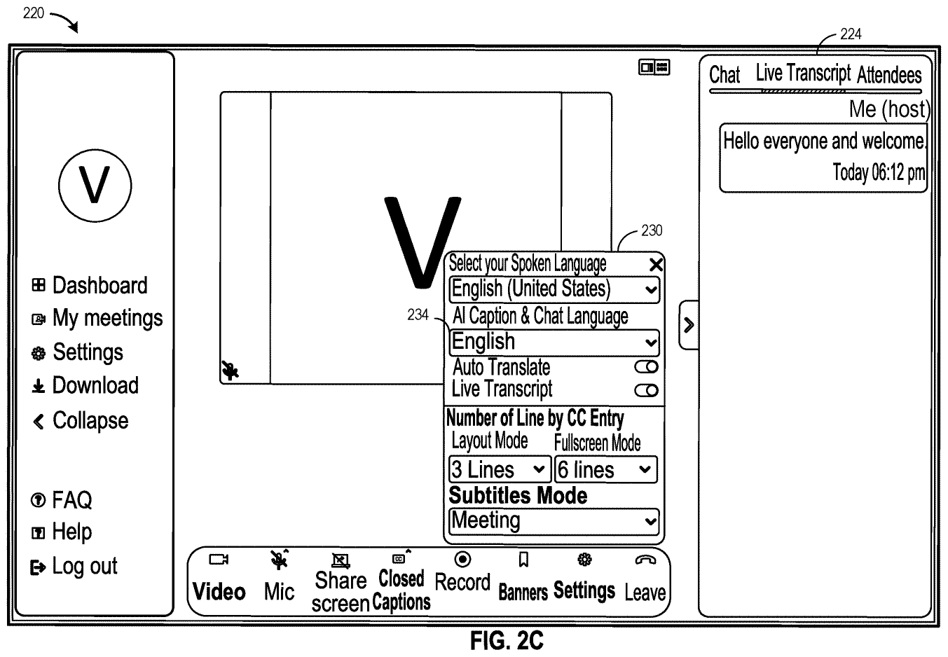

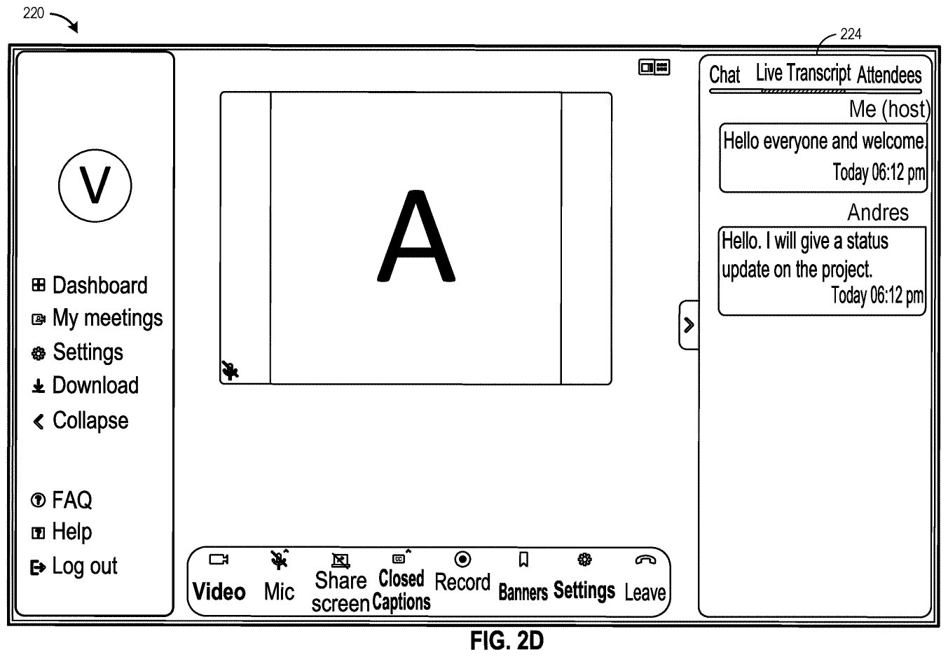

FIGS. 2A-2D depict graphical user interfaces of the transcription and translation system 104. In FIG. 2A, the graphical user interface 200 can be a launch user interface. A user can set a spoken language setting via selection of the first user interface element 202. A user can set a caption and/or chat language setting via selection of the second user interface element 204. A user can join a meeting via selection of the third user interface element 206.

In FIG. 2B, the graphical user interface 220 can be a meeting user interface. A user can select the audio user interface element 222 to provide audio input. As described herein, a user can speak in a first language, which can be received by the transcription and translation system 104. The transcription and translation system 104 can receive the audio (such as the utterance “Hello everyone and welcome”), detect words from the audio, and translate the words in the first language to a second language (such as “Hola a todos y bienvenidos”). As shown, the translated text can be shown in the graphical user interface 220, such as the substantially real-time transcript area 224.

In FIG. 2C, a user can change the meeting settings via selection of a setting in the settings area 230. As shown, a user can change the caption and/or chat language setting via selection of the user interface element 234 in the settings area 230. As shown, in response to a user changing the caption and/or chat language setting, the transcription and translation system 104 can dynamically translate the chat and/or live transcript text to the selected language. As shown, the transcription and translation system 104 can dynamically change the text in the substantially real-time transcript area 224 (here the text “Hello everyone and welcome” is shown).

In FIG. 2D, the graphical user interface 220 can provide output associated with other participants in the meeting. Each of the other participants can provide input to the transcription and translation system 104 via respective client computing devices and graphical user interfaces. As shown, another participant (here Andres) can speak an utterance (such as “Hola, dare una actualización del estado del Proyecto”) or provide written input in their own language (which can be different from the preferred language of the user of the graphical user interface 220). In response to the user's previous selection of a caption and/or chat language setting, the transcription and translation system 104 can dynamically translate the chat and/or live transcript text from the other participant to the selected language. As shown, the transcription and translation system 104 can dynamically provide translated text in the graphical user interface 220, such as the substantially real-time transcript area 224.

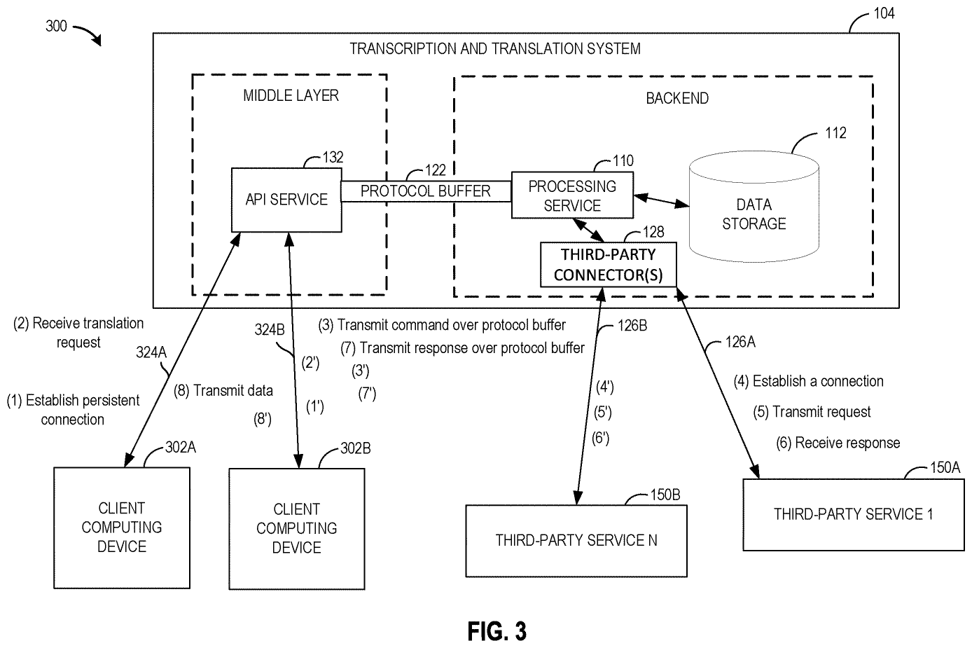

With reference to FIG. 3, in some embodiments, illustrative interactions are depicted regarding the transcription and translation system 104 and managing translation requests. The interactions shown and described with respect to FIG. 3 can illustrate one or more aspects that may be related to enabling substantially real-time speech-to-text transcription, speech-to-speech translation, and/or speech-to-text translation. The interactions shown and described with respect to FIG. 3 can illustrate one or more aspects that may be related to providing improved speech-to-text transcription, speech-to-speech translation, and/or speech-to-text translation functionality by integrating third-party API functions available in multiple programming languages. In FIG. 3, the environment 300 may be similar to the environment 100 of FIG. 1. The environment 300 can include the transcription and translation system 104, a first client computing device 102A, a second client computing device 102B, a first third-party service 150A, and a second third-party service 150B. Other interactions (not illustrated) may be possible in accordance with the present disclosure in other embodiments. Similar to the communication depictions of FIG. 1, not every possible communication may be depicted in FIG. 3.

The interactions of FIG. 3 begin at one (1), where a persistent connection 324A can be established. The first client computing device 302A can open a persistent connection 324A with the API service 132. The API service 132 can confirm the persistent connection 324A between the API service 132 and the first client computing device 302A. As described herein, the persistent connection 324A can be implemented with WebSockets technology. The client computing device 302A can transmit a translation request to the API service 132 over the persistent connection 324A. In some aspects, transmitting requests and responses over the persistent connection 324A can conserve computing resources. For example, instead of opening and closing multiple connections between the API service 132 and the client computing device 302A during a stream, the API service 132 and the client computing device 302A can maintain a persistent connection 324A, which can avoid incurring the computing resource costs for opening and closing multiple connections. As described herein, using fewer computing resources for connection-related tasks can enable substantially real-time transcription and/or translation functionality. The translation request can include audio data or text data. The audio data can include speech in a source language. The text data can include text written in a source language. For example, the source language can be English. The audio data or text data can originate from the first client computing device 302A.

At two (2), the API service 132 can receive the translation request from the first client computing device 302A. The API service 132 can determine a command associated with the received translation request. For example, if the translation request includes audio data in a source language, the API service 132 can determine a translation command to convert the audio data into output associated with a target language.

At three (3), the API service 132 can transmit the command over the protocol buffer 122 to the processing service 110. The processing service 110 can determine what action(s) to take in response to receiving the command. For example, in response to receiving a command to convert text or audio, the processing service 110 can initiate one or more requests to third-party translation service(s). The processing service 110 can access the data storage 112 and determine the preferred target language(s) of the client computing device(s) 302A, 302B. In the example, one target language can be Spanish. If multiple client computing devices should receive translated data in different languages, the processing service 110 can generate the third-party requests for the different languages. As described herein, the processing service 110 can determine which third party service out of multiple third-party services to direct a request. As described herein, the processing service 110 can be programmed in a programming language (such as Rust) that uses fewer computing resources when executing in contrast with other programming languages.

In some aspects, communicating over a protocol buffer can conserve computing resources. For example, instead of transmitting JSON messages between the API service 132 and the processing service 110 during stream(s), the API service 132 and the processing service 110 can communicate over the protocol buffer. Existing methods for generating JSON messages can be slower than generating protocol buffer messages, such as by using less computer processor cycles to generate the protocol buffer messages. Moreover, existing methods for transmitting JSON messages between services can be several times slower (such as five or six times slower) than transmitting protocol buffer messages between services. As described herein, using fewer computing resources for intra-service communication related tasks can enable substantially real-time transcription and/or translation features.

At four (4), a third-party connector 128 can establish a connection with a first third-party service 150A with a third-party API. In some aspects, reusing the same connection with a third-party service can conserve computing resources. At five (5), the third-party connector 128 can transmit, via the connection, a third-party request associated with the command. The third-party connector 128 can transmit, via a third-party API in a first programming language (such as C#, for example), the third-party request. The processing service 110 can be configured to communicate with different third-party APIs (sometimes from the same third-party service) in different programming languages. As described herein, the functionality offered by a third-part API can differ based on the programming language being used. In some embodiments, but for the various integrations of the processing service 110, the functionality from third-party APIs in different programming languages would not be available. The third-party request can include a source language indicator (such as a code for the source language), a target language indicator (such as a code for the target language), and the audio data or text data. The first third-party service 150A can process the third-party request. The first third-party service 150A can perform automatic speech recognition on the audio data and convert text from the source language to the target language. For example, the first third-party service 150A can convert the audio data where speech is in English to text in Spanish. Moreover, for other requests, the first third-party service 150A can output the text in other target languages. The first third-party service can transmit, via the connection 126A, a response to the third-party request.

At six (6), the third-party connector 128 can, via the connection and the third-party API, receive a response from the first third-party service 150A. The response can include output (such as text data) in the target language associated with the target language indicator. At seven (7), the processing service 110 can transmit response(s) associated with the received command(s) over the protocol buffer 122. At eight (8), the API service 132 can transmit, via the persistent connection 324A, a response to the first client computing device 302A. The response can include translated text data for the translation request. The translated text data can be in the target language (such as Spanish, for example). As described herein, the API service 132 can provide response data to other client computing devices, such as the second client computing device 302B. The response data to other client computing devices can include different translated text in different target languages. For example, the audio data from the first client computing device 302A can be translated to text in another target language (such as Brazilian) and provided to the second client computing device 302B.

In FIG. 3, one-prime (1′), two-prime (2′), three-prime (3′), four-prime (4′), five-prime (5′), six-prime (6′), seven-prime (7′), and eight-prime (8′) can be similar to one (1), two (2), three (3), four (4), five (5), six (6), seven (7), and eight (8), respectively. At one-prime (1′), a persistent connection 324B is established; the second client computing device 302B can open a persistent connection 324B with the API service 132. At two-prime (2′), the API service 132 can receive a second translation request from the second client computing device 302B. At three-prime (3′), the API service 132 can transmit a command over the protocol buffer 122 to the processing service 110. At four-prime (4′), a third-party connector 128 can establish a connection with a second third-party service 150B with a second third-party API. At five-prime (5′), the third-party connector 128 can transmit, via the connection, a second third-party request associated with the command. The third-party connector 128 can transmit, via a second third-party API in a second programming language (such as JavaScript, for example), the second third-party request. As described herein, instead of transcription and translation system 104 servicing the first translation request via a first third-party API in a first programming language, the transcription and translation system 104 servicing the first translation request via a second third-party API in a different, second programming language, which can provide different functions (such as, but not limited to, different available languages, speech-to-speech functionality, etc.) than the API in the first programming language. At six-prime (6′), the third-party connector 128 can, via the connection and the second third-party API, receive a response from the second third-party service 150B. At seven-prime (7′), the processing service 110 can transmit response(s) associated with the received command(s) over the protocol buffer 122. At eight-prime (8′), the API service 132 can transmit, via the persistent connection 324B, a response to the second client computing device 302B.

In some aspects, the described technologies with respect to FIG. 3 or a combination thereof, such as, but not limited to, persistent connections, protocol buffers, and/or the specific programming language used can contribute to substantially real-time transcription and/or translation for multiple participants. For example, multiple client computing devices 302A, 302B that are streaming data during a meeting can be provided with substantially real-time transcriptions and/or translations.

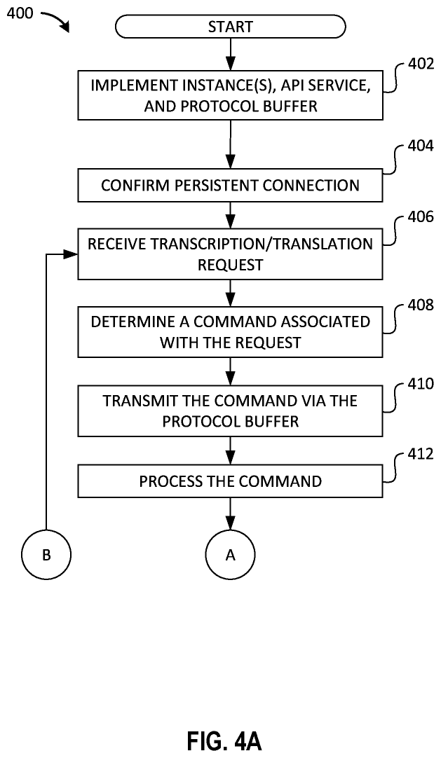

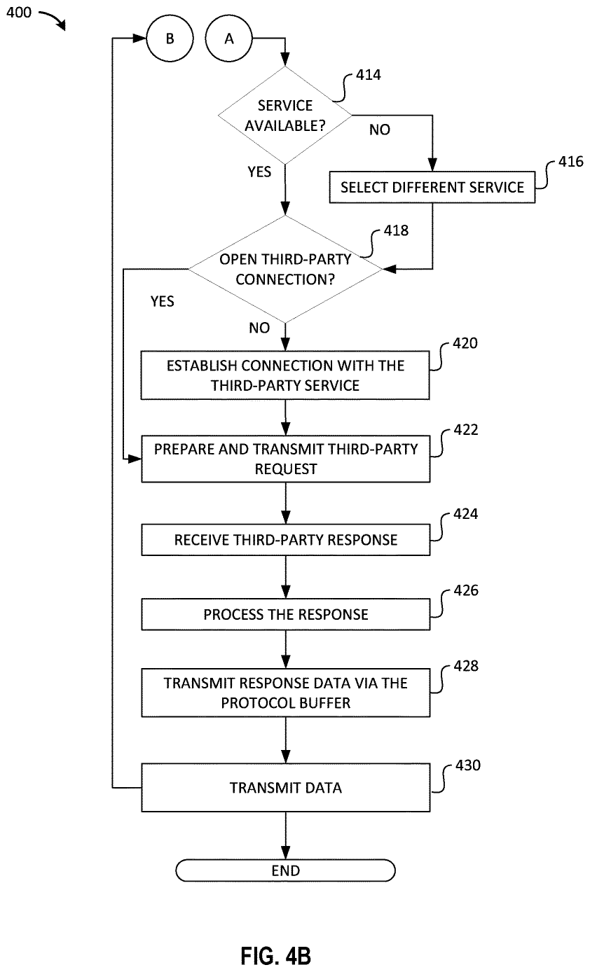

FIGS. 4A-4B are flow charts depicting a method 400 implemented by the transcription and translation system 104 for substantially real-time speech transcription and/or translation. The method 400 can enable substantially real-time speech-to-text transcription, speech-to-speech translation, and/or speech-to-text translation features, where some of these features were not available in existing real-time audio or video platforms. In particular, the substantially real-time transcription and/or translation can be enabled by use of a programming language that results in using fewer computing resources for execution. Moreover, the method 400 can implement and use protocol buffers and/or reuse connections to result in usage of fewer computing resources, which can enable substantially real-time transcription and/or translation. The method 400 can also enable improved transcription and/or translation features via integration with multiple different third-party transcription and translation services and/or libraries.

At block 402, instances of the transcription and translation system 104 can be implemented. The API service 132 and the protocol buffer 122 can be implemented. As described herein, the transcription and translation system 104 can be implemented by one or more virtual machines implemented in a hosted computing environment. Different instances of the transcription and translation system 104 can be implemented in different geographical regions to provide client computing devices with improved latency based on geographical location. In some embodiments, each instance of the transcription and translation system 104 can implement an API service 132 and a protocol buffer 122. As described herein, the protocol buffer 122 can be implemented with (but is not limited to) Protocol Buffer (also known as Protobuf) from Google. The protocol buffer 122 as implemented can be configured to serialize data for transmission between the API service 132 and the processing service 110. The API service 132, as implemented, can be configured to receive language translation and/or transcription requests. As described herein, the transcription and translation system 104 can be used with client computing devices in a meeting setting, where the transcription and translation system 104 can provide transcriptions and/or translations in substantially real-time with the meeting. The API service 132 and/or the processing service 110 can include computer-executable instructions programmed in a Rust programming language. As described herein, the Rust programming language used for the services 110, 132 can advantageously provide increased (such as a 3-fold increase compared to other programming languages) responsiveness and speed (such as using fewer computing resources) when executing.

At block 404, a persistent connection can be confirmed. A client computing device 102A. 102B, 102C, 102D can request to open a persistent connection with the API service 132. The API service 132 can send an acknowledgement to the client computing device 102A, 102B, 102C, 102D that confirms the persistent connection. The request and acknowledgement process can also be referred to as a connection handshake. As described herein, the persistent connection between the API service 132 and the client computing device 102A, 102B, 102C, 102D can be implemented with WebSockets. The API service 132 and the client computing devices 102A, 102B, 102C, 102D can advantageously send messages (including data payloads with transcription and/or translation requests and/or responses) back and forth over the same persistent connection. Using persistent connections can advantageously avoid additional overhead costs (which uses fewer computing resources) associated with creating and tearing down connections. Therefore, persistent connection technology can, at least in part, assist in achieving substantially real-time transcriptions and/or translations. Once the API service 132 confirms the persistent connection with the client computing device 102A, 102B, 102C, 102D, the persistent connection can be used multiple times.

At block 406, a transcription and/or translation request can be received. The API service 132 can receive a transcription and/or translation request from a client computing device 102A, 102B, 102C, 102D. The transcription and/or translation request can be received via the persistent connection. The transcription and/or translation request can include input data (audio or text data) associated with a source language. The audio data can include speech in a source language. As described herein, such as with respect to FIG. 2B, a user can provide audio input for transcription and/or translation. The text data can include text in the source language. As described herein, such as with respect to FIG. 2C, text can be sent from the client computing device 102A to the transcription and translation system 104. The audio data and/or text data can be obtained from a meeting with multiple participants. In some embodiments, the request can include the source language and/or the target language (such as language indicator(s)). In other embodiments, the transcription and translation system 104 can store the source language and/or target language preference for a particular client or user profile and that information can be omitted from the request.

At block 408, a command can be determined that is associated with the request. In response to receiving the transcription and/or translation request, the API service 132 can, substantially in real-time, determine a command associated with the request. For example, if the request is a translation request including audio data, then the API service 132 (in the middle layer) can determine a corresponding translation command to be sent to the processing service 110 (in the backend). As another example, if the request is a transcription request including audio data, then the API service 132 (in the middle layer) can determine a corresponding transcription command to be sent to the processing service 110 (in the backend). In some embodiments, the API service 132 can serialize data (such as the audio or text data) into the command. The API service 132 can determine other related data to include in the command, such as, but not limited to, a user profile identifier, a source language indicator, and/or a target language indicator.

At block 410, the command can be transmitted via the protocol buffer 122. In response to receiving the transcription and/or translation request, the API service 132 can, substantially in real-time, transmit the command via the protocol buffer. The protocol buffer 122 can enable fast and efficient communication (using fewer computing resources) via transmitting commands from the client API service 132 to the processing service 110.

At block 412, the command can be processed. The processing service 110 can process the command. The processing service 110 can determine which third-party service 150A, 150B to use to process the command associated with the transcription and/or translation request. In some embodiments, the processing service 110 can determine which third-party service 150A, 150B to use before the command is received; in other embodiments, the processing service 110 can determine which third-party service 150A, 150B to use in response to receiving the command. The processing service 110 can determine, via a configuration mapping, that a particular third-party API supports translation to the target language or from the source language. In some embodiments, the configuration mapping can map third-party APIs to supported languages. The configuration mapping can map third-party APIs to other functions, such as, for example, speech-to-speech functionality. Additionally or alternatively, the configuration mapping can further map particular third-party API functions to supported languages for each function. The configuration mapping can be stored in the data storage 112. The processing service 110 can determine a source language and/or a target language associated with the request. In some embodiments, the preferences for a profile associated with the client computing device can be stored in the data storage 112, which can include the source language and/or target language preferences for the profile. The processing service 110 can determine a third-party API that is configured to translate the target language. As described herein, different third-party services can provide support for different target languages and/or source languages. The processing service 110 can select, from multiple third-party APIs, a particular third-party API based at least in part on the particular third-party API being configured to translate the target language. The processing service 110 can execute the commands having been programmed in a programming language, such as, but not limited to Rust. The programming language (such as Rust) of the processing service 110 can advantageously use fewer computing resources (resulting in faster speed such as a 3-fold increase compared to other programming languages) when executing the commands.

In some embodiments, the processing service 110 can select a third-party service based at least in part on latency. As described herein, a third-party API can support multiple regions (which can also be referred to as nodes) and the instance of the transcription and translation system 104 can select the region that is appropriate for the instance. The processing service 110 can select from among multiple regions for a third-party API based at least in part on latency. The processing service 110 can determine a first latency associated with the third-party API at a first region and a second latency associated with the third-party API at a second region. The processing service 110 can select, from among the first region and the second region, the third-party API at the first region based at least in part on the first latency and the second latency. For example, the processing service 110 can select the region with the lowest latency or the latency that satisfies some threshold.

The processing service 110 can determine the API function to call appropriate for the command. For example, if the request was for a translation, the processing service 110 can identify a translation function from the third-party API. As another example, if the request was for a transcription, the processing service 110 can identify a transcription function from the third-party API.

In some embodiments, the processing service 110 can determine multiple API calls based on a single received command. In a meeting context, the processing service 110 can determine that other client computing devices 102A, 102B, 102C, 102D in the meeting should receive transcription or translation data. The processing service 110 can determine that multiple API calls may need to be generated based on the target language for each of the other client computing devices 102A, 102B, 102C, 102D. In other embodiments, it can be the responsibility of other client computing devices 102A, 102B, 102C, 102D to request translations based on the audio or text data received from the originating client computing device.

In FIG. 4B, at block 414, it can be determined whether the third-party service is available. As described herein, the processing service 110 can execute failover logic such that if a first service 150A is unavailable, the processing service 110 can switch to a second service 150B. The processing service 110 can determine that a third-party API is unavailable. For example, a third-party API may become unresponsive and not respond to one or more requests from the transcription and translation system 104. If the third-party service is available, the method 400 can proceed to block 418 to determine whether a connection is open with the third-party service. Otherwise, if the third-party service is unavailable the method 400 can proceed to block 416 to select a different third-party service.

At block 416, the processing service 110 can select, from among multiple third-party services, an alternative third-party service based at least in part on the prior third-party service being unavailable. The processing service 110 can select a different region for the third-party service if another region for the third-party service is available. The processing service 110 can select a different third-party service provided by a different organization as a failover contingency. In some embodiments, the processing service 110 can use the configuration mapping to select a compatible third-party service, as described herein.

At block 418, it can be determined whether there is an open connection with the third-party service. The processing service 110 and/or the third-party connector 128 can determine whether there is an open connection with the third-party service. As described herein, the same connection created by the third-party connector 128 can be reused for multiple different API calls, which can be associated with requests from different client computing devices 102A, 102B, 102C, 102D. If a connection with the third-party service is open, then the method 400 can proceed to block 422 to prepare and transmit a third-party request. Otherwise, the method 400 can proceed to block 420 to establish a connection with the third-party service. At block 420, a connection with the third-party service can be established. The third-party connector 128 can establish a connection with the third-party service. As described herein, the third-party API for the third-party service can be in a particular programming language.

At block 422, a request to the third-party service can be prepared and transmitted. The processing service 110 can prepare a third-party request that includes (i) a source language indicator associated with the source language, (ii) a target language indicator associated with the target language, and (iii) input data (such as audio data or text data). In the case of a transcription request, the processing service 110 can prepare a third-party request that includes (i) a source language indicator associated with the source language and (ii) audio data. The request can also include an indicator regarding the type of request, such as, but not limited to, a speech-to-text, text-to-text, text-to-speech, or speech-to-speech request type. In response to receiving the transcription and/or translation request, the third-party connector 128 can, substantially in real-time, transmit (via the third-party API) the third-party request associated with the command. As described herein, the third-party connector 128 can transmit the request via the third-party API in a programming language, where different third-party APIs can use different programming languages.

At block 424, a response from the third-party service can be received. The third-party connector 128 can receive output data (such as text data or audio data) from the third-party API of the third-party service. The output data, such as the text data or audio data, can be in the target language. At block 426, the response can be processed. The processing service 110 can process the response received from the third-party service. The processing service 110 can determine one or more recipients (such as the client computing devices 102A, 102B, 102C, 102D) for the response. The processing service 110 can identify the client computing device 102A, 102B, 102C, 102D that requested the transcription and/or translation as a recipient. The processing service 110 can identify other client computing devices 102A, 102B, 102C, 102D that should receive response data. In a meeting context, the processing service 110 can determine that other client computing devices 102A, 102B, 102C, 102D in the meeting should receive response data. At block 428, response data can be transmitted via the protocol buffer 122. The processing service 110 can transmit response data via the protocol buffer 122 to the API service 132. As described herein, transmissions via the protocol buffer 122 can enable fast and efficient communication (using fewer computing resources) between the processing service 110 and the client API service 132.

At block 430, data can be transmitted to the client computing device 102A, 102B, 102C, 102D. The API service 132 can transmit output data (such as transcribed/translated text or translated audio) to the client computing device 102A, 102B, 102C, 102D. As described herein, the output data can be transmitted via the persistent connection. Depending on the embodiment, the client computing device 102A, 102B, 102C, 102D can cause presentation of the output data. As described herein, such as with respect to FIG. 2C, the transcribed and/or translated data can be presented in a graphical user interface. In the case of audio output data, the client computing device 102A, 102B, 102C, 102D can output the translated audio data.

### Audio to Audio

Some embodiments can enable users to communicate voice to voice with a virtual translator. Voice to voice embodiments can be enabled with a phone call that may not require use of an application or other graphical user interface. The phone call can be initiated in any manner, including through an operator, using a special number or string of numbers, and/or through an application. In some embodiments, a user can append a voice-to-voice translation phone number before or after the number of the person they seek to telephone. Using such techniques, a phone system can automatically route the call for voice-to-voice translation. In some embodiments, the two phone users can have their own phone service providers that routes through a translation service. For example, the calls can be routed through a third-party telecommunications server, such as Vonage. The translation service can be provided in an intermediate location. As described herein, the speech-to-speech process can include initial speech to text translation into the target language and text to speech, voice synthesizing.

In particular, some embodiments enable users to communicate voice to voice with a virtual translator. For example, a first user can speak, the first user's speech is automatically translated, and during a pause initiated by the first user, the translated speech is spoken by a generated voice such that a second user hears the translation in the second user's language, and vice versa. This can provide a virtual, substantially real-time translation experience. The system can support the first user and the second user can be in the same physical location and the same audio device can be used to facilitate the automated translation. The system can also support each using their own audio device. Advantageously, the one or more audio devices can call a telephone number with translation capabilities and no software installation may be necessary.

In some embodiments, the described systems and methods can reduce a need for live translators and expand hiring opportunities for companies such as large retailers or other service providers. A first employee (e.g., a supervisor) can speak into their audio device (such as a phone) in a first language, while one or more employees can hear the supervisor through their own audio devices (such as phones) in their own languages; or the translation and voice synthesizing can occur over the same audio device. Thus, a manager speaking a first language can provide clear direction to a team of workers, even if the workers speak different language(s). In turn, those workers can respond in their own languages while the supervisor hears each response in the first language. Team members can similarly communicate with each other. In an employment scenario such as described here, the system can also allow saving of a record of instructions and responses, including precise wording (in multiple languages) and time information. Thus, a supervisor's delegation or other task description skills can be evaluated, rewarded, and/or improved after the fact. Similarly, a worker's responsiveness to instructions can be assessed from a written record. Transcription and written translation can be saved but not displayed if employers and/or workers prefer not to see or reveal such records (in real time or otherwise). In some embodiments, the system can automatically delete such records or avoid saving them. Another use for such potentially stored historical transcription and translation data is to improve the system itself. Thus, actual latency can be measured from time stamps in such data, and accuracy of translations can also be assessed from the saved data.

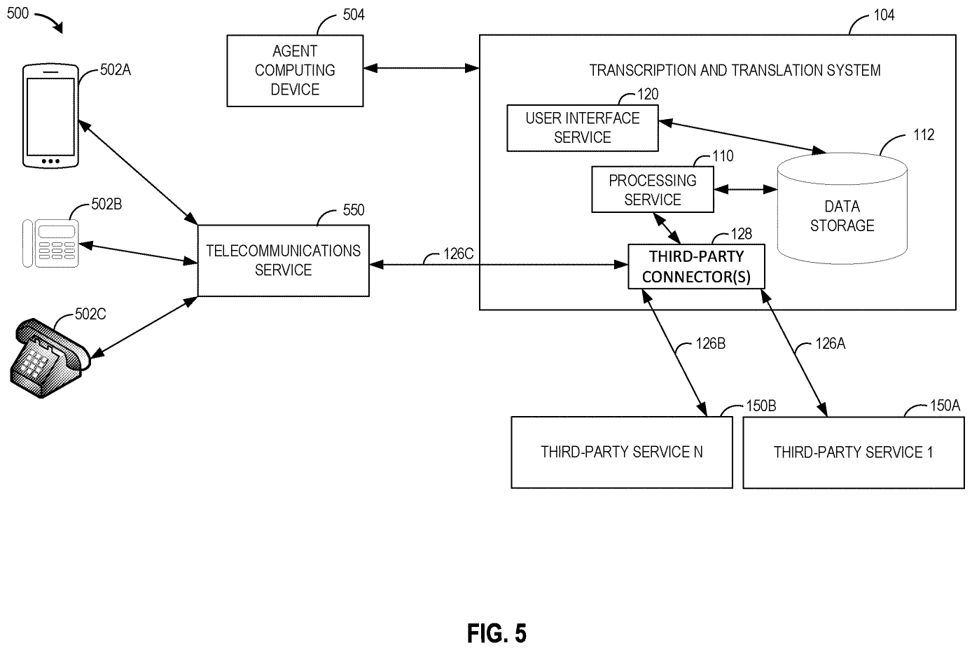

Turning to FIG. 5, an illustrative environment 500 is shown in which a transcription and translation system 104 may facilitate substantially real-time, speech-to-speech translation. The environment 500 of FIG. 5 can be similar to the environment 100 of FIG. 1. The environment 500 may include one or more audio devices 502A, 502B, 502C, an agent computing device 504, a telecommunications service 550, one or more third-party services 150A, 150B, and the transcription and translation system 104. The constituents of the environment 500 may be in communication with each other either locally or over one or more networks. While certain constituents of the environment 500 are depicted as being in communication with one another, any constituent of the environment 500 can communicate with any other constituent of the environment 500; however, not all of these communication lines are depicted in FIG. 5.

The audio devices 502A, 502B, 502C can include, but are not limited to, a mobile phone, a smartphone, a Voice over Internet Protocol phone, and/or a telephone. The audio devices 502A, 502B, 502C can connect to the telecommunications service 550 to make a phone call. The audio devices 502A, 502B, 502C can communicate with the telecommunications service 550 over a telephone network, a cellular network, local area network, wide area network, cable network, satellite network, a personal area network, or combination thereof. For example, the audio device 502A, 502B, 502C can communicate with the telecommunications service 550 over a Public Switched Telephone Network. The telecommunications service 550 can be a third-party service, such as, but not limited to, Vonage.

In some embodiments, a user, via the audio device 502A, 502B, 502C can dial a specific phone number that routes the audio device 502A, 502B, 502C to the telecommunications service 550. The audio device 502A, 502B, 502C, via the telecommunications service 550, can output prompts from an Interactive Voice Response system, also known as an IVR. The IVR can receive one or more source languages and/or target languages. The transcript of Table 1 (rows 1 and 3) below provides example IVR prompts and the IVR can determine one or more languages from responses to the prompts. In some embodiments, the telecommunications service 550 can select a default language based on the geolocation (such as a county) of the audio device 502A, 502B, 502C based on respective phone numbers. The telecommunications service 550 can connect the audio device 502A, 502B, 502C to the transcription and translation system 104 via a third-party connector 128.

TABLE 1

| | |
|---|---|
| 1 | Interactive Voice Response System: Press or say 1 for English/United States; 2 for |
| | Spanish/Mexico; or tell us the country in English to detect language. |
| 2 | Speaker 1: United States |
| 3 | IVR System: You selected English/United States. Select your second language. |
| | Please choose an option. Press or say 1 for English/United States; 2 for Spanish/ |
| | Mexico; or tell us the country in English to detect language. |
| 4 | Speaker 1: Mexico |
| 5 | IVR System: You selected Spanish/Mexico. Wait while the application connects |
| | you to the call service. You can start talking after the tone. <Beep> |
| 6 | Speaker 1: Good afternoon. <Pause> |
| 7 | Automated Translator: Buenas tardes. |
| 8 | Speaker 2: Buenas tardes. ¿Como puedo ayudarle? <Pause> |
| 9 | Automated Translator: Good afternoon. How can I help you? |
| 10 | Speaker 1: I'm looking for some equipment. <Pause> |
| 11 | Automated Translator: Estoy buscando algun equipo. |
| 12 | Speaker 2: Excelente. ¿Que tipo de equipo? <Pause> |
| 13 | Automated Translator: Great. What type of equipment? |

The third-party connector 128 can create a connection 126C, such as a persistent connection, with the telecommunications service 550. In some embodiments, the telecommunications service 550 can also communicate via an HTTP-based callback function, such as a webhook. The telecommunications service 550 can, substantially in real-time, transmit audio data to the third-party connector 128. The third-party connector 128 can cause the audio data to be processed, such as by changing a frequency of the audio data, which can facilitate later processing by a third-party service 150A, 150B. The processed audio data, such as the audio data with a changed frequency, can be processed specifically for the third-party service 150A, 150B. The processing service 110 can asynchronously cause speech-to-text and the text-to-speech conversion and buffer the translated audio output. The processing service 110 can also detect a pause in the audio. If the audio pause satisfies a time threshold (such as 1.5 seconds or 1 second for example), then the processing service 110 can initiate formatting the output audio into a compatible frequency and causing playback of the generated audio output. In other embodiments, the third-party service 150A, 150B can perform speech-to-speech translation directly.

The transcription and translation system 104 can generate translation and/or synthetization commands for the third-party service 150A, 150B. In some embodiments, the API of the third-party service 150A, 150B may support automatic detection of a source language and/or allow one or more target languages to be provided. For example, the third-party service 150A, 150B can receive two or more target languages (such as English and Spanish, for example) and if the audio contains speech in a first language (such as English) then the third-party service 150A, 150B can translate the audio into the second language (such as Spanish); similarly, if the audio contains speech in the second language (such as Spanish) then the third-party service 150A, 150B can translate the audio into the first language (such as English). In some embodiments, the third-party service 150A, 150B can select the first target language from multiple target languages that is different than the detected source language. As described herein, in some aspects, an advantage of the transcription and translation system 104 is the support for multiple third-party APIs, multiple third-party services 150A, 150B, and/or multiple versions of the same third-party API. For example, other third-party APIs may not support automatic detection and translation in a single third-party API function call. Accordingly, the transcription and translation system 104 can support language detection on the audio and then separately invoking translation of the audio based on the detected source language and a target language. However, if the auto-detection and translation of audio third-party API is supported, then the transcription and translation system 104 can make use of that third-party API instead of another third-party API since the former API may execute with fewer computing resources than the latter.

The transcription and translation system 104 can transmit the translated audio in an automatically generated voice to the telecommunications service 550. Accordingly, as indicated by the transcript of Table 1 (which may be only a portion of a phone call with automated translation), the telecommunications service 550 can output the translated audio following pauses by the speakers. In some embodiments, an agent, via the agent computing device 504 can initiate a translation-enabled phone call between the audio devices 502A, 502B, 502C. Agent initiated phone calls with speech-to-speech translation can be optional. As described herein, the user interface service 120 can provide user interfaces to the agent computing device 504 that allow an agent to configure and initiate phone calls with speech-to-speech translation.

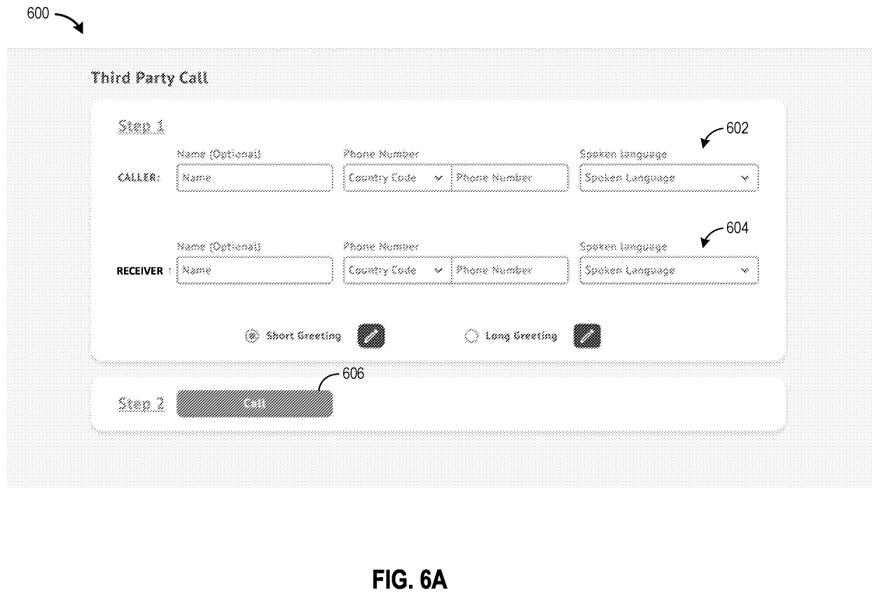

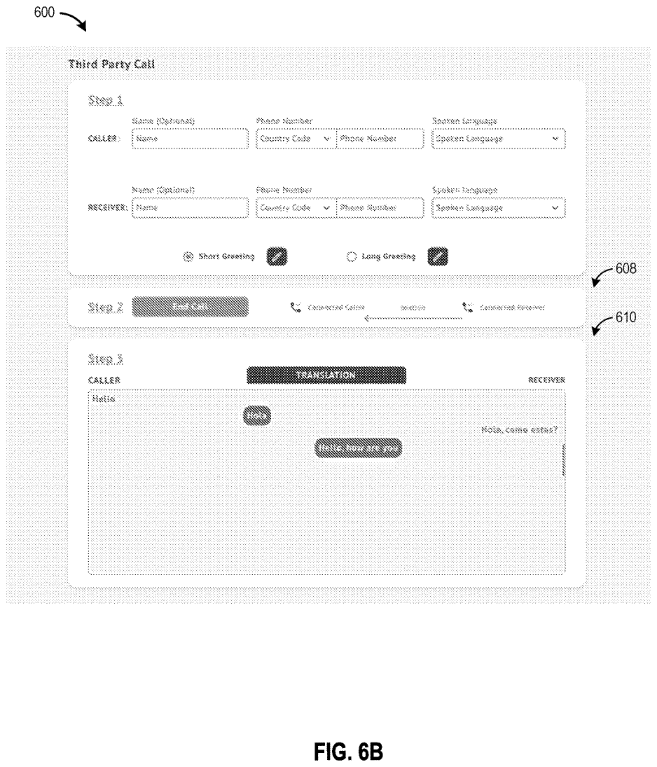

FIGS. 6A-6B depict call management graphical user interfaces of the transcription and translation system 104. In FIG. 6A, the graphical user interface 600 can be a call user interface. An agent user can provide a first phone number and set a first spoken language setting via the first user input elements 602. The agent user can provide a second phone number and set a second spoken language setting via the second user input elements 604. The agent user can initiate the phone call with speech-to-speech translation via selection of the call user interface element 606. Upon selection of the call user interface element 606, the transcription and translation system 104 can initiate, via the telecommunications service 550, a phone call between the audio devices.

In FIG. 6B, the graphical user interface 600 can depict a call in progress. The graphical user interface 600 can update substantially in real-time as the speakers talk during the call. The graphical user interface 600 can include a metadata area 608 and a transcript area 610. The metadata area 608 can indicate the status of the call. The transcript area 610 can update substantially in real-time as speech from the call is transcribed and translated.

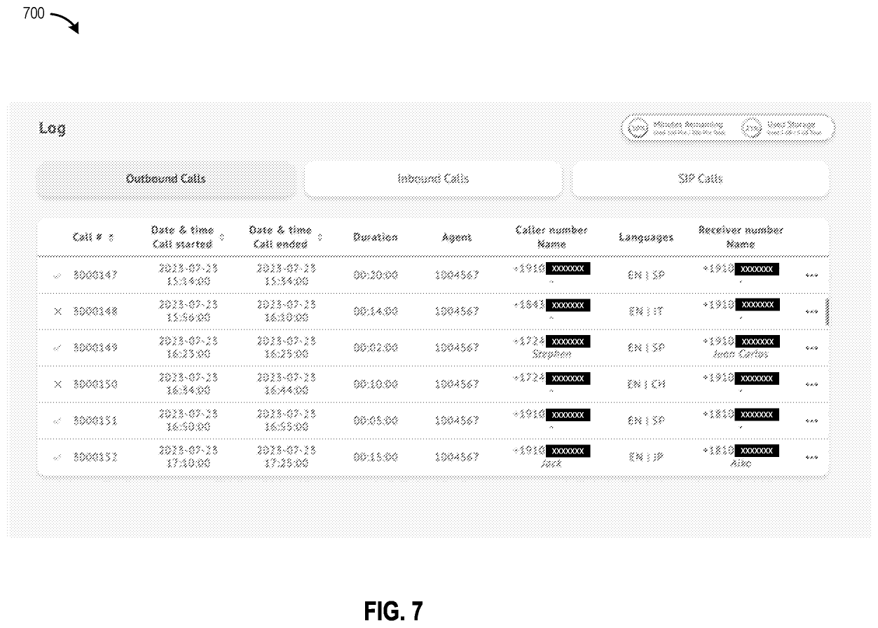

FIG. 7 depicts another call management graphical user interface 700 of the transcription and translation system 104. The call management graphical user interface 700 can present call logs for outbound and inbound phone calls. The call management graphical user interface 700 can also present a separate call log for VoIP and/or internet-based phone calls.

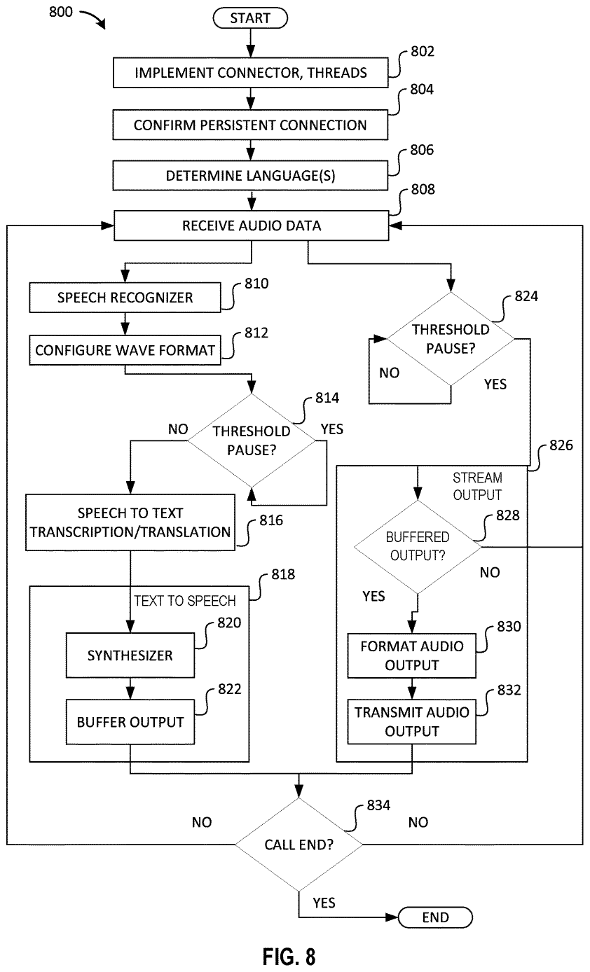

FIG. 8 is a flow chart depicting a method 800 implemented by the transcription and translation system 104 for substantially real-time speech-to-speech translation. The method 800 can enable substantially real-time speech-to-speech translation features, where some of these features were not available in existing real-time audio or video platforms. In particular, the substantially real-time speech-to-speech translation can be enabled by the architecture and/or algorithms described herein. Moreover, the method 800 can reuse connections to result in usage of fewer computing resources, which can enable substantially real-time speech-to-speech translation. The method 800 can also enable improved speech-to-speech translation features via integration with multiple different third-party transcription and translation services and/or libraries.

At block 802, a connector 128 can be implemented. As described herein, the transcription and translation system 104 can be implemented by one or more virtual machines implemented in a hosted computing environment. As described herein, the transcription and translation system 104 can be used with a telecommunications service 550, where the transcription and translation system 104 can provide speech-to-speech translations in substantially real-time during a phone call. The connector 128 can connect with the telecommunications service 550 and can receive audio data for translation. The transcription and translation system 104 can be implemented with multiple threads and the threads can execute asynchronously. The processing service 110 can be multi-threaded and can parallel process speech translation and audio output streaming. Additional aspects of the transcription and translation system 104 can be implemented, which can be described in further detail herein, such as with respect to FIG. 4A and the block 402 for implementing aspects of the system 104.

At block 804, a persistent connection can be confirmed. In some embodiments, the telecommunications service 550 can request to open a persistent connection with the connector 128. The connector 128 can send an acknowledgement to the telecommunications service 550 that confirms the persistent connection. The request and acknowledgement process can also be referred to as a connection handshake. As described herein, the persistent connection between the connector 128 and the telecommunications service 550 can be implemented with WebSockets. The connector 128 and the telecommunications service 550 can advantageously send messages (including data payloads with audio data) back and forth over the same persistent connection. Using persistent connections can advantageously avoid additional overhead costs (which uses fewer computing resources) associated with creating and tearing down connections. Therefore, persistent connection technology can, at least in part, assist in achieving substantially real-time speech-to-speech translations. Once the connector 128 confirms the persistent connection with the telecommunications service 550, the persistent connection can be used multiple times.

At block 806, one or more languages can be determined. The processing service 110 can determine the languages differently depending on the implementation. As described herein, in the case of an audio phone call with an IVR, one or more speakers can indicate their languages. For example, multiple languages can be indicated for a phone call. In some embodiments, the telecommunications service 550 can provide data indicating the speaker responses to languages, which can be provided over a persistent connection. A user can specify one or more languages via a graphical user interface. In the case of an agent initiated phone call, the agent can specify the languages via a graphical user interface. The processing service 110 can determine language indicators for the identified languages.

At block 808, audio data can be received. The connector 128 can receive audio data from the telecommunications service 550. The audio data can be an audio stream of a phone call. The audio data can be received via a persistent connection. The audio data can have different sample rates, such as sixteen kilohertz or eight kilohertz. Following receipt of the audio data, the processing service 110 can parallel process the input audio data and output audio data. The method can proceed to the block 810 to initialize a speech recognizer and the block 824 to check for a pause.

At block 810, a speech recognizer can be defined. The processing service 110 can instantiate a speech recognizer. In some embodiments, the speech recognizer can be a class from a library provided by a third party. The speech recognizer can communicate with a third-party translation service 150A, 150B. The speech recognizer can receive audio data.

At block 812, a wave format can be configured. The processing service 110 can configure the wave format based on a frequency of the input audio data. The configured wave format can be used to format the audio data that can be received by the speech recognizer. The processing service 110 can determine a frequency of the audio data that is used to configure the wave format. If the input audio data is 16 kHz, the processing service 110 can configure the wave format for 16 kHz. If the input audio data is 8 kHz, the processing service 110 can configure the wave format for 8 kHz.

At block 814, it can be determined whether there is a pause in speech in the audio data. The processing service 110 can determine, from the audio data, whether there is a pause in the speech that satisfies a threshold time period (such as one second or 1.5 seconds). If there isn't a pause, the method 800 can proceed to block 816 to perform speech to text processing. If there is a pause, the method 800 can wait until further audio is received with speech.

At block 816, speech to text transcription and/or translation can be performed. In some embodiments, the processing service 110 can process the audio data. The processing service 110 can generate audio data based on the initial audio data according to the determined frequency (such as 8 kHz or 16 kHz). The format of the generated audio data can depend on the third-party translation service, such as, but not limited to, a waveform audio file format. Depending on the type of audio call and the third-party API used, the processing service 110 can generate different transcription and/or translation commands. For example, in the case of a single audio source (such as a single audio device with multiple speakers), the processing service 110 can configure third-party API calls that perform automatic speech detection and that receive multiple target languages where the third-party service can identify the appropriate target language based on the detected source language. In some embodiments, the connector 128 can transmit, via a third-party API, a third-party translation request that includes (i) the generated audio data and (ii) one or more target language indicators. In other cases, such as where there are multiple input audio streams (such as multiple audio devices) and each stream can be associated with a particular language, then the processing service 110 can configure third-party API calls where the source and target language are known for each audio stream. In some embodiments, the connector 128 can transmit, via a third-party API, a third-party translation request that includes the (i) generated audio data, (ii) a first language indicator for a source language, and (iii) a second language indicator for a target language. In some cases, the processing service 110 can cause transcription in the source language first and then translation can occur at the synthetization stage. In some embodiments, the connector 128 can transmit, via a third-party API, a third-party transcription request comprising (i) generated audio data and (ii) a language indicator for a source language. The connector 128 can receive, from the third-party AI, text data in response to the request. The text data can be in the source language or the target language depending on the case and/or embodiment.

At block 818, text to speech can be performed. The block 818 for text to speech processing can include the blocks 820, 822 for speech synthesizing and buffering output. At block 820, speech can be synthesized. Depending on the type of audio call and the third-party API used, the processing service 110 can generate different synthetization commands. For example, in the case of a single audio source, the processing service 110 can configure a third-party API call that synthesizes already translated text. In some embodiments, the connector 128 can transmit, via a third-party API, a third-party synthetization request that includes the translated text data. In some cases, where the transcribed text is in the source language, the processing service 110 can request translation at the synthetization stage. In some embodiments, the connector 128 can transmit, via a third-party API, a third-party synthetization request including (i) the transcribed text data and (ii) a language indicator for a target language. The connector 128 can receive, from the third-party API, output audio data in the target language. In some embodiments, the processing service 110 can select a synthetization profile based on the original input audio. The output audio data can have a frequency, such as a sample rate at 8 kHz or 16 kHz. At block 822, the output audio data can be buffered. The processing service 110 can place the output audio data in a buffer.

At block 834, it can be determined whether the call has ended. If the call hasn't ended, the processing service 110 can proceed in a loop processing audio data by returning to block 808 to receive more audio data. In some embodiments, the blocks 810, 812 for creating a speech recognizer and configuring wave formats may not be repeated per audio stream. In other embodiments, the blocks 810, 812 for creating a speech recognizer and configuring wave formats can be repeated if the sample rate of the audio stream can change mid-stream.

At block 824, it can be determined whether there is a pause in speech in the audio data. The processing service 110 can determine, from the audio data, whether there is a pause in the speech that satisfies the threshold time period (such as one second or 1.5 seconds). If there is a pause, the method 800 can proceed to block 826 to perform streaming output. If there is not a pause, the method 800 can wait until further audio is received with a pause in speech.

At block 826, audio output can be streamed. The block 818 for streaming audio output can include the blocks 828, 830, 832 for checking for buffered output, formatting the audio output, and transmitting the audio output. At block 828, it can be determined whether there is output audio in the buffer. The processing service 110 can determine, from the buffer, whether there is audio output from the previously described block 822 that buffered output. If there is buffered output, the method 800 can proceed to block 830 to format the audio output. If buffered output is not present, the method 800 can return to block 808 to receive additional audio data and proceed in a loop until another pause is detected.

At block 830, the audio output can be formatted. The processing service 110 can format the audio output. The processing service 110 can determine a frequency of the audio output. The processing service 110 can generate audio data based on the output audio data according to the determined frequency (such as 8 kHz or 16 kHz) and/or requirements for the telecommunications service 550. In some embodiments, the processing service 110 can format the audio output for the telecommunications service 550 by splitting the buffered output into portions (which can be referred to as chunks). The processing service 110 can determine a size of the portions based on the determined frequency. In some embodiments, for a first frequency (such as 8 kHz), the processing service 110 can determine the number of portions by dividing the buffer length by a first number of bytes (such as 320 bytes). In some embodiments, for a second frequency (such as 16 kHz), the processing service 110 can determine the number of portions by dividing the buffer length by a second number of bytes (such as 640 bytes).

At block 832, the generated audio output can be transmitted. The processing service 110 can transmit the generated audio output via the persistent connection to the telecommunications service 550. As described herein, the telecommunications service 550 can then transmit the generated audio output to audio device(s) 502A, 502B, 502C connected to the phone call.

At block 834, it can be determined whether the call has ended. If the call hasn't ended, the processing service 110 can proceed in a loop for outputting audio data by returning to block 808 to receive more audio data.

Live and/or Virtual Events

Some embodiments can enable substantially real-time transcription and translation of live and/or virtual events. A live and/or virtual event conference can be integrated with the transcription and translation system 104.

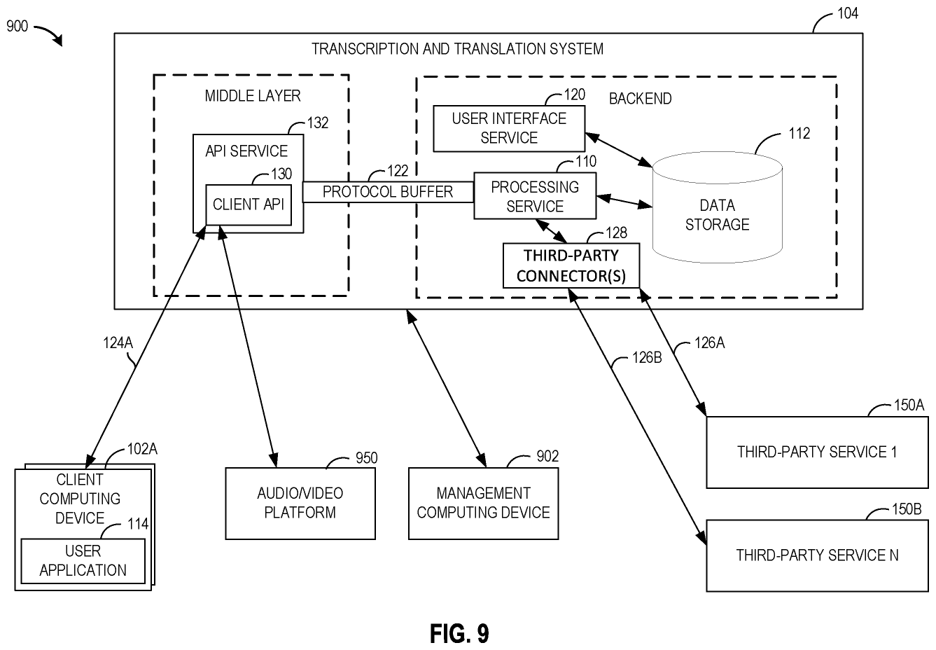

Turning to FIG. 9, an illustrative environment 500 is shown in which a transcription and translation system 104 may facilitate substantially real-time, transcription and translation of live and/or virtual events. The environment 900 of FIG. 9 can be similar to the environment 100 of FIG. 1. The environment 900 may include one or more client computing devices 102A, a management computing device 902, an audio/video platform 950, one or more third-party services 150A, 150B, and the transcription and translation system 104. The constituents of the environment 900 may be in communication with each other either locally or over one or more networks. While certain constituents of the environment 900 are depicted as being in communication with one another, any constituent of the environment 900 can communicate with any other constituent of the environment 500; however, not all of these communication lines are depicted in FIG. 9.

A management computing device 902 can include, but are not limited to, a laptop or tablet computer, personal computer, and/or a smartphone. An administrator, via the management computing device 902, can use graphical user interfaces to configure transcription and/or translation features for a live and/or virtual event. For example, the administrator can configure one or more languages for speakers and/or one or more target languages. The administrator can also configure the video and/or audio input streams for the live and/or virtual event. In some embodiments, such as where the application 114 is a web browser application, the user interface service 120 can provide graphical user interfaces to the web browser application. The processing service 110 can determine source and/or target languages associated with an event. In some embodiments, the source languages can be determined via user interface selections by an administrator. In some embodiments, during the event, an administrator can identify the speaker speaking, which can be associated with a particular source language. Additionally or alternatively, the transcription and translation system 104 can cause the source language being spoken to be automatically determined, as described herein.

In some embodiments, the audio/video platform 950 can stream audio data to the transcription and translation system 104 via the client API 130. The audio/video platform 950 can also stream video data to the transcription and translation system 104. The audio/video platform 950 (which can include an audio/video computing device) can have a persistent connection with the client API service 132. The API service 132 can confirm a persistent connection between the API service 132 and an audio/video computing device. As described herein, the processing service 110 can cause the audio (such as audio from one or more speakers at the live and/or virtual event) to be translated into the one or more target languages by a third-party service 150A, 150B. The third-party service 150A, 150B can translate the speech into translated text and/or speech. The processing service 110 can add the text data and/or output audio data to a repository associated with a particular language channel. The transcription and translation system 104 can make one or more channels available to the client computing devices 102A, where each channel can be for a particular target language. In particular, the processing service 110 can determine the client computing device(s) 102A that are subscribed to a particular language channel. The processing service 110 can cause the translated text and/or speech to be transmitted to the subscribed client computing device(s) via persistent connections.

As described herein, the client computing device 102A can include, but are not limited to, a laptop or tablet computer, personal computer, personal digital assistant (PDA), hybrid PDA/mobile phone, smart wearable device (such as a smart watch), mobile phone, and/or a smartphone. The API service 132 can confirm a persistent connection between the API service 132 and the client computing device 102A. A user, via the user application 114, can participate in the live and/or virtual event by selecting a channel and receiving the translated text and/or speech. In some embodiments, the transcription and translation system 104 can provide a code, such as a QR code, that when scanned causes an attendee graphical user interface to be presented on the client computing device 102A.

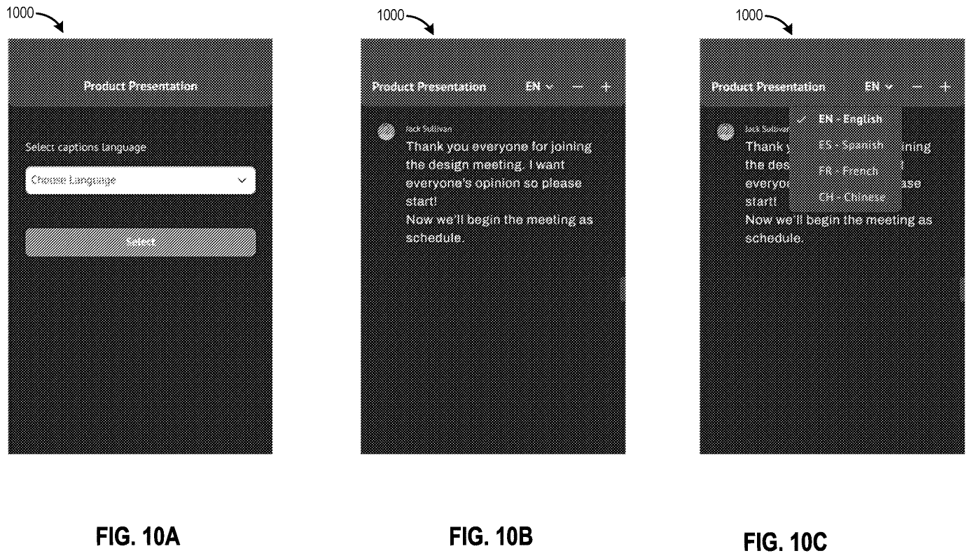

FIGS. 10A-10C depict attendee graphical user interfaces of the transcription and translation system 104. In FIG. 10A, the graphical user interface 1000 can be an attendee user interface. An attendee user can select a target language setting in the graphical user interface 1000. In FIG. 10B, the graphical user interface 1000 can present automatic speech-to-text captioning of the live and/or virtual event. In some embodiments, while not illustrated, such as where the attendee is remote, the graphical user interface 1000 can present a video of live and/or virtual event. The graphical user interface 1000 can also output audio for the translated speech. In FIG. 10C, an attendee user can change the target language setting in the graphical user interface 1000.

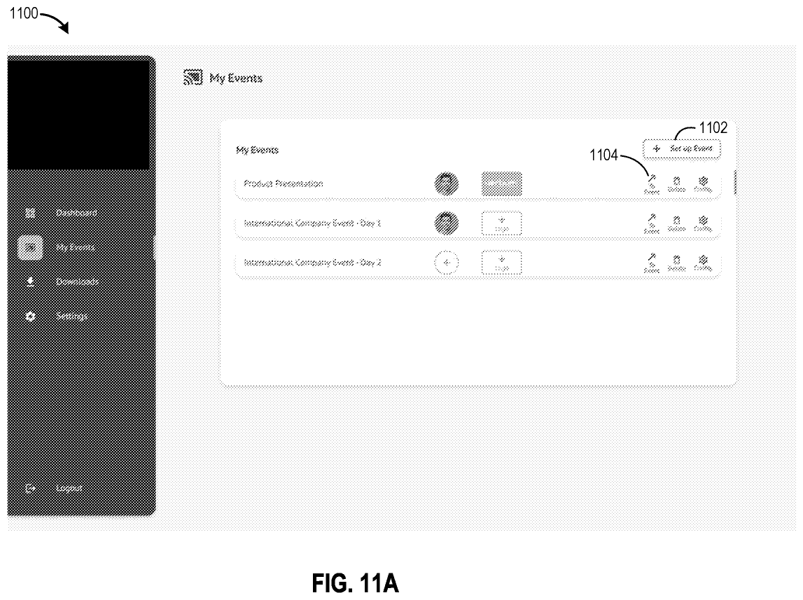

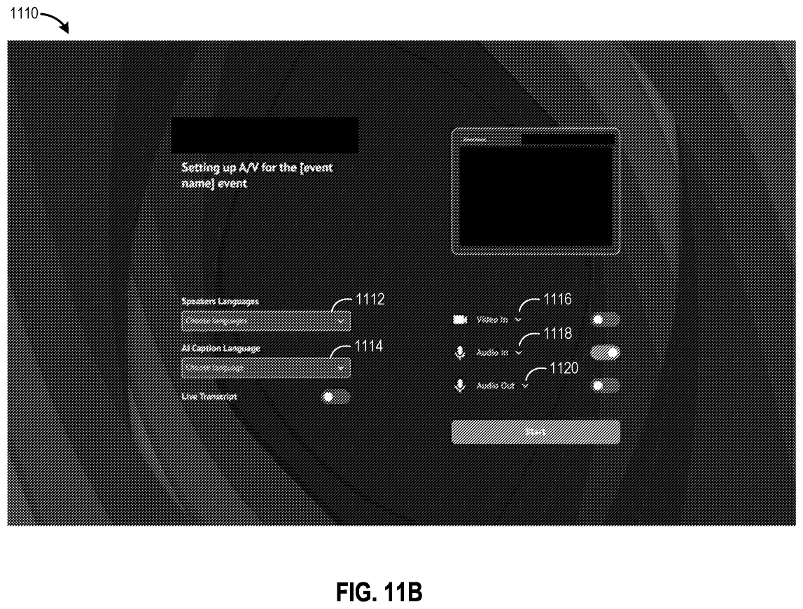

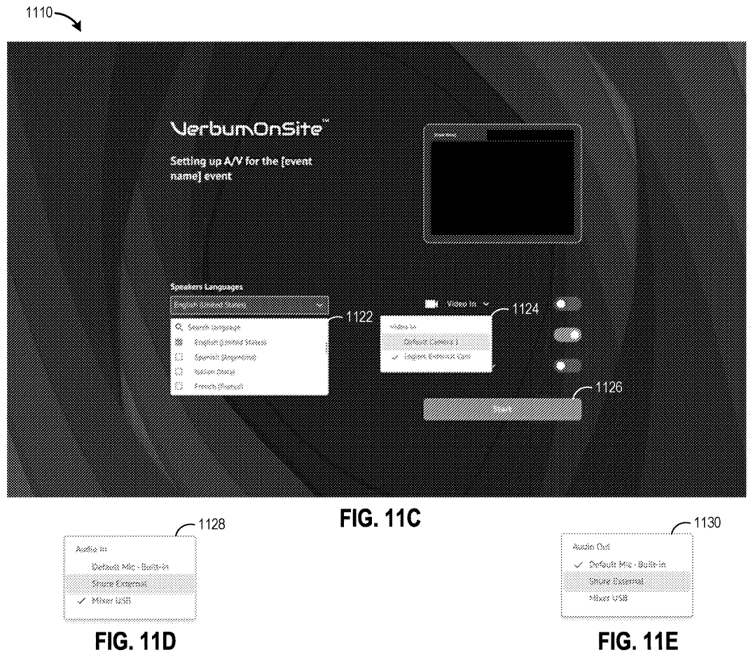

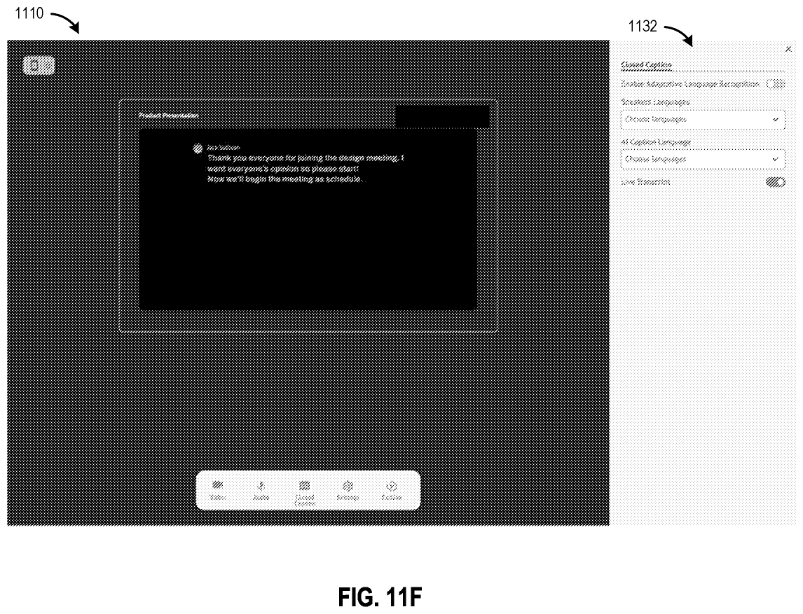

FIGS. 11A-11F depict event management graphical user interfaces and user interface elements of the transcription and translation system 104. In FIG. 11A, the graphical user interface 1100 can be an event management user interface. As depicted, the graphical user interface 1100 can present events that are managed by an administrator user. An administrator user can create a new event by selecting the first user input element 1102. The administrator user can proceed to the live and/or virtual event by selecting the second user input element 1104.

In FIG. 11B, the graphical user interface 1110 can be a launch user interface. An administrator user can set one or more speaker language settings via selection of the first user interface element 1112. A user can set one or more caption and/or chat language settings via selection of the second user interface element 1114. The administrator user can set video settings for the event via selection of the third user interface element 1116. The administrator user can set audio input settings for the event via selection of the fourth user interface element 1118. The administrator user can set audio output settings for the event via selection of the fifth user interface element 1120.

In FIG. 11C, the graphical user interface 1110 can include settings options 1122, 1124. The administrator user can select one or more speaker language settings from the language settings options 1122. The administrator user can select video settings from the video settings options 1124. The administrator user can initiate the event via selection of the sixth user interface element 1126. In FIG. 11D, the depicted audio input settings 1128 can be presented in the graphical user interface 1110 of FIGS. 11B, 11C. In FIG. 11E, the depicted audio output settings 1130 can be presented in the graphical user interface 1110 of FIGS. 11B, 11C.

In FIG. 11F, the graphical user interface 1110 can be an event user interface. During the event, an administrator user can manage the live and/or virtual event. For example, the administrator user can dynamically change one or more source and/or target languages via the language settings elements 1132. In some embodiments, the administrator user can enable automatic language detection via selection of the corresponding user interface element in the language settings elements 1132.

### Sentiment Analysis and Reporting

In some embodiments, a system can provide a characterization of the sentiment (e.g., tone, inflection, emotional state, etc.) of the people conversing. This can be determined with audio clues. For example, a sudden increase in volume or speed can be associated with excitement or anger. Audio sentiment algorithms can be employed, and the results can be reflected in a visual or written report of the call. An audio sentiment analysis methodology can use dense vector representations of words that capture semantic meaning, such as Word2Vec, and/or term frequency-inverse document frequency. Audio sentiment analysis can be perform by a third-party service. In some embodiments, a third-party service can receive the vector representations.

A color system can be used to indicate one or more sentiments, and the color of the text or of icons or other illustrative features associated with the text can indicate the sentiment (which may also be reflected in, or derived from, words and/or expressions in the transcript itself). In some embodiments, a key can be provided showing the meaning of an array of colors indicating sentiment. For example, some systems or rubrics developed by Gloria Willcox in approximately 1982 use six base emotional descriptors developed by comprising peaceful (blue), powerful (green), joyful (yellow), scared (orange), made (red), and sad (purple). Various other more nuanced emotional states can be grouped within these general areas in a color-wheel arrangement. For example, scared can include more pale orange associated with rejected, confused, helpless, submissive, insecure, and anxious, for example. Such color rubrics can be used to characterize not only the words, but the sentiment and feeling of a transcribed conversation. Reports can include this sentiment analysis, using various mechanisms (colors, numerical scores or ranges, symbolic or graphical representations, etc.). Feedback can be provided through the system to evaluate and/or improve algorithms used for purposes of sentiment. Thus, automated reporting (which can include sentiment analysis and reporting) can provide a benefit for the described systems. Engagement of a conversation's participants can also be measured and reported (e.g., as part of sentiment). This analysis and reporting can be used to automatically evaluate success of marketing or other phone interactions, even without a need for survey questions or other more time consuming feedback collection.

In some embodiments, sentiment detection and/or analysis can also be used to tune sentiment or conveyed expressed by a synthetized voice output. Thus, a synthetic voice outputting a translated version of a user's speech can employ emotions or emphasis similar to the emotions or emphasis provided by the initial speaker. An angry input can result in an angry-sounding output. A peaceful input can result in a peaceful output. This can also improve communication efficiency because non-textual clues can convey information efficiently, especially when combined with the transcribed and translated text itself. Moreover, sentiment analysis can improve translation. Some expressions are more commonly used when a speaker is angry, but would be inappropriate—or unlikely to reflect true intended meaning—when a speaker is sad. Accordingly, a range of vocabulary and other linguistic options can be correlated to a currently-measured sentiment score or level. Idiomatic usages and phrase substitution can thus depend on a sentiment analysis, thereby improving translation choices by the automated system.

### Geographic Architecture

To enable low latency and other efficiencies (including cost efficiency), multiple third-party servers can be available to serve as the centralized automation and translation service location for calls originating in different geographic locations. For example, servers for third-party translation service can be selected at or near trunk line exit or entry points for countries. If particular nodes are more frequently used, additional repositories or servers can be established at or near these nodes. In some cases, higher speed, lower-cost or lower-use phone network pathways can be calculated or used for routing calls under the disclosed voice-to-voice systems. Pre-distribution, on-demand, and/or dynamic adjustment of the location of translation servers can provide efficiency under the described systems. For pre-distribution, the locations for efficient translation can be predicted. For on-demand or dynamic adjustment, software packages, modules, virtual servers, etc. can be established or selected as needed, at nodes or in places calculated on an ad-hoc basis. Thus, when a call or request originates from Iceland targeting Tallahassee, for example, a package of relevant software, libraries, and memory can be promptly sent for installation and/or selected for use near a trunk-line node near Nova Scotia, for example. Alternatively, a translation server package or module may already be present in or near New York City. Because this node is already located between source and destination for this call, no new package or module installation may be warranted. Determinations for such module usage and/or installation can be automated, and coordinated with call routing decisions and/or requests.

### Synthetization

As described herein, transcribed and translated speech can be synthetized with an automated voice. In some embodiments, the synthetized voice is selected or established based on similarity to the originator's voice. Accordingly, it can be advantageous to have a large library of voice types and timbres, allowing for improved matching. The synthetization process can comprise a measurement or evaluation process of an incoming voice. For example, low and high extremes can be tracked to provide for a range in various spaces or dimensions (e.g., using statistical analysis). For example, a loudness range or midpoint, a pitch range or midpoint, a speaking speed, an accent, and/or other measures of articulation, timbre, etc. can be evaluated. If the available automated voices are stored according to particular scores or standardized measures based on a similar evaluation process, a statistical best fit can be established. In some embodiments, a best fit for one or more measurements can be used, while a separate measurement is artificially adjusted to provide a raw fit in some dimensions and a synthetic best fit in some or in a combination of dimensions. For example, a speaking speed, accent, and timbre can be matched using a raw best fit, while a loudness and pitch are then artificially adjusted with audio post-processing to achieve a best overall or hybrid fit. In some embodiments, active feedback can be provided to improve synthetization as a call progress (or as a system is used for more and more users). Thus, artificial intelligence and model training data can be used through the described system to improve audio results, especially in a voice-to-voice call context.

Processing of speech from one language to another can be accomplished using six modules, for example. Three modules—speech to text (transcription), text to text (translation), and text to speech (synthetization)—can be used for each speaker/hearer pair, and if both people take turns speaking, six modules can be used, for example. Processing modules can be consolidated or distributed. For example, the voice recognition and text translation modules can be located in a centralized server location for resource sharing. In some embodiments, each of the one or more synthetization modules is also located in a centralized server location (e.g., the same server as the other modules), thereby allowing transmission of data to and from the centralized server to occur using standard VoIP protocols. Alternatively, each of the one or more synthetization modules can be located in a server relatively closer to an end user location (e.g., a last mile or local server, or locally at a user device), thereby limiting transmission distance of audio data and increasing transmission distance of precursor text data.

### Voice Profiles, Geographic Efficiencies

In some embodiments, a limited set of initial voices can be used to establish faster algorithmic matching, if some voices provide a better base sound for later synthetic adjustment. In some embodiments, an originating country or other location can be used for the system to establish a starting point or foundation voice typical to callers from a country or region of the world. In this manner, multiple steps can be made more efficient (on average) using geographic information inherent in a phone number or other internet protocol or addressing information that may be available (e.g., through VoIP calls). For example, if a call shows that it originates in Quebec, Canada, Canadian French can be initially selected for the automated translation (as opposed to translation being tuned to the argot of Madagascar, Brussels, Marseille, or Paris). Similarly, at least as a default, a set of voices can be associated with particular regions of the world. These can be sorted into higher, lower, faster, slower, more or less feminine or masculine, etc. Any geographic pattern can be used to establish efficiency in default parameters, libraries, voices, etc. Thus, both translation and synthetization steps can provide efficiency for a voice-to-voice system.

### Bridge Embodiments

Bridge embodiments can be those that enable multiple translators to collaborate in real time for a large conference. In some embodiments, a system can provide and/or integrate with a Remote Simultaneous Interpretation (RSI) platform and a Global Communications System (GCS). For example, the architecture described herein can allow over 75,000 users to communicate in any language at any time during a single event. Simultaneous interpretation with multiple interpreters and languages is provided. The system can provide rapid close-captioning, as described herein. The system can allow chatting in more than 80 languages with very low latency such that “live” subtitling and interpretation is provided to all users. The system can provide high-resolution videoconferencing with very low bandwidth. The system provides granular controls, including more than eight different managing roles like Host, Speaker, Attendee, Interpreter, Producer, Technician, Moderator, etc.

A bridge graphical user interface can include controls and feeds for various users in various roles. There can be different interpreter audio feeds, each having various related associated controls such as a source selection tool, a relief selection tool, a microphone button, a volume, and a view selection tool. A portion of the graphical user interface can provide a view of a main event speaker, with associated controls such as a live subtitle toggle, a channel room volume, a floor language, and how many live speakers are active. The graphical user interface can include a live speaker window and a backstage speakers window. The signals can be labeled, the source language can be identified, microphone controls can be provided, and speaker identities can be shown. The graphical user interface can include an interpreter chat interface, where collaborating interpreters can communicate.

The graphical user interface can include an insights dashboard, analytics, an overall summary with registered users, information regarding users that agreed to share information, attendees to signed up, users, etc. The graphical user interface can allow data export (e.g., in CSV format or to platforms such as Marketo, Salesforce, Huspot, etc.).

For a live-event translator collaboration system such as described here, a browser-based application can be used. This can allow the solution to be highly scalable for running small and large events. For a live-event translator collaboration system such as described here, interactions can be rewarded, and data flow and lead integrations are provided. Event metrics can be viewed in a convenient dashboard available for some user roles. Data privacy and compliance can be provided, for example through a single login and engagement add-ons.

### International Organization Embodiments

Some embodiments can be useful for a large international body such as the United Nations, where many participants have their own language or dialect, but also speak one of a few more common or “bridging” international languages (e.g., English, French, and/or Spanish). Previously, translation for large international conferences occurred using many live interpreters, transmitting audio to individual devices of attendees. The disclosed systems can provide automated subtitles with very low latency and high accuracy. For example, a single large screen can be provided that automatically shows close-captioning and/or subtitles in one or more main languages (e.g., three main languages). In some embodiments, no bridging languages are required because the low latency systems described can provide live closed captioning on individual devices of attendees in many native languages (e.g., 82 languages).

### Personal Translator Embodiments

In some embodiments, a system can be used to translate and/or provide transcription (e.g., low-latency closed captioning with over 90% accuracy) in numerous (e.g., over 80) languages for an existing stream of audio or video. For example, a user can position a smartphone running an application as described here next to a radio or television news feed for a live event such as a Queen's funeral or a political speech. The system can provide real-time closed captioning and translation for that user. An interface can be provided where the application shows only or mainly the translated closed captioning against a high contrast background, for example, in a dedicated live-event translation and transcription mode. A local microphone or software-based virtual microphone “wrapper” (see further description below) can be used to assist in such embodiments.

### Local Microphone

In some embodiments, a microphone wrapper can be provided in a computing environment (e.g., a windows or Apple PC). A microphone wrapper can be a software module that interacts with the system similarly to how a regular microphone would interact with that system. However, a microphone wrapper can serve as a virtual or software-only microphone. An operating system can include a virtual microphone as one of the options, next to the regular hardware microphones to which it may be connected. By routing audio information through this microphone wrapper, data can be processed prior to leaving the computer. In this way, translation, transcription, or other functions as described herein can occur locally.

A microphone wrapper also has applications to security and encryption. As voice identification and other biometric approaches grow, users may need to protect their voice to avoid biometric impersonation, for example. Thus, voice files can be processed locally using a microphone wrapper and encrypted or encapsulated before sending, even before leaving a virtual microphone processor or a microphone wrapper, for example.

Locally saved modules can enable light versions that save translation and/or interpretation modules on a per-language basis, saved at a browser and/or mobile device level.

### Other System Efficiencies

Another source of efficiency is the concentration of automation in a centralized position or entity. For example, a working environment can be established to efficiently share resources, virtual or otherwise. The automated services can share a security perimeter and/or authentication or security process. A single copy of relevant translation libraries can be centrally stored or accessible, for use in this consolidated processing example. Thus, no translation libraries need be duplicated, limiting memory storage and enabling rapid data transmission for translation purposes. The same centralization efficiencies apply to synthetization: voice models and stored files and sounds can be stored centrally, and accessed rapidly.

In some embodiments, the benefits described herein can be significant sources of efficiency in a voice-to-voice translation system. These can include integration with telecommunication servers or other devices at a low level (e.g., a socket level), avoiding computer language translation, additional hardware or software, and other delays, for example. These sources of efficiency can also include use of multiple artificial intelligence systems or services (e.g., and strategic deployment of one or another based on cost, availability, proximity, interoperability, intervening infrastructure, speed, or other technical benefits).

Multiple benefits are provided in described systems. For example, these systems can be carrier agnostic. For example, they can be designed for efficient use with any carrier or multiple carriers by using computer software and hardware connections and base units that are common to multiple carriers. One benefit is the absence of any administrative or surface layer, reducing a need for graphic interfaces, training, or other teaching actions. Another benefit is related to the underlying features, such as low latency (high speed) and high accuracy that may result from use of socket layer integration. For example, where a Parisian calling a rustic Wyoming cowboy can invoke: an initial Frent to English transcription/translation (or a French to French transcription and a French to English translation depending on the implementation) and a text to voice rendering (using synthetization) of the translation into spoken English. In parallel, for the speech by the cowboy, an initial transcription/translation can be performed and then rendered in a French voice (e.g., using a voice similar to that of the cowboy).

The described systems can include benefits from the automated feature of built-in transcription. That is, since the translation algorithms typically rely on initial transcription, and the translation output is also in text form (e.g., before being transformed by or output using a synthetized voice), a transcript in each language is already a natural byproduct of the service, without requiring further processing. The described systems can include automated reporting features. For example, a phone call summary (e.g., source destination, duration, routing, cost, etc.) can be provided in a report that is emailed or otherwise provided after a translated call. A report can include a transcript in both languages (which can be provided efficiently, as explained above). The report can also include sentiment information, as described herein.

### Additional Implementation Details

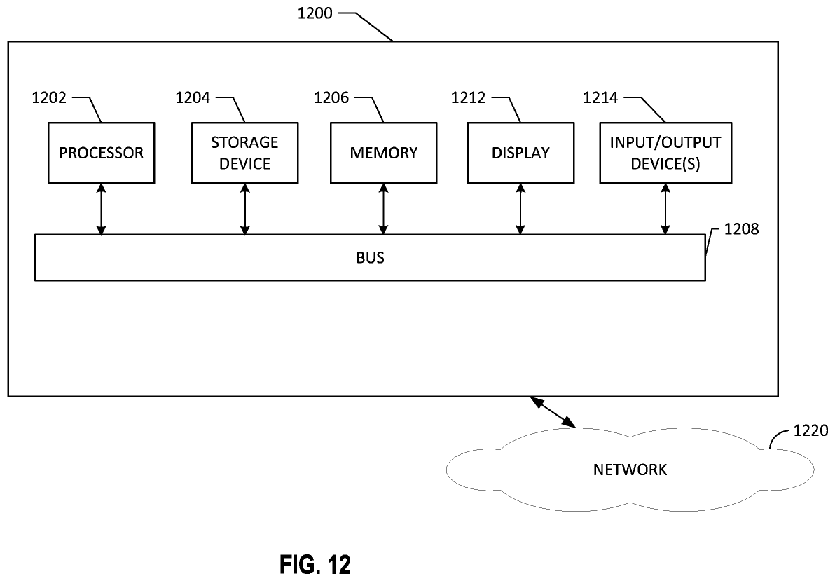

FIG. 12 is a block diagram that illustrates example components of a computing device 1200. The computing device 1200 can implement aspects of the present disclosure. Using FIG. 1 as an example, components of the transcription and translation system 104 of FIG. 1 can be implemented in a similar manner as the computing device 1200. Similarly, client computing devices 102A, 102B, 102C, 102D can be implemented in a similar manner as the computing device 1200 of FIG. 12. The computing device 1200 can communicate with other computing devices via the network 1220.

The computing device 1200 can include a hardware processor 1202, a data storage device 1204, a memory device 1206, a bus 1208, a display 1212, and one or more input/output devices 1214. The hardware processor 1202 can also be implemented as a combination of computing devices, e.g., a combination of a digital signal processor and a microprocessor, a plurality of microprocessors, one or more microprocessors in conjunction with a digital signal processor, or any other such configuration. The hardware processor 1202 can be configured, among other things, to execute instructions to perform one or more functions. The data storage device 1204 can include a magnetic disk, optical disk, solid state drive, or flash drive, etc., and is provided and coupled to the bus 1208 for storing information and instructions. The memory device 1206 can include one or more memory devices that store data, such as, without limitation, random access memory (RAM) and read-only memory (ROM). The computing device 1200 may be coupled via the bus 1208 to the display 1212, such as an LCD display or touch screen, for displaying information to a user, such as an engineer. The computing device 1200 may be coupled via the bus 1208 to one or more input/output devices 1214. The input device 1214 can include, but is not limited to, a keyboard, mouse, digital pen, microphone, or touch screen.

The network 1220 may be any wired network, wireless network, or combination thereof. In addition, the network 1220 may be a personal area network, local area network, wide area network, cable network, satellite network, telephone network, or combination thereof. In addition, the network 1220 may be a publicly accessible network of linked networks, possibly operated by various distinct parties, such as the Internet. In some embodiments, the network 1220 may be a private or semi-private network, such as a corporate or university intranet. The network 1220 may include one or more wireless networks, such as a Global System for Mobile Communications (GSM) network, a Code Division Multiple Access (CDMA) network, a Long-Term Evolution (LTE) network, or any other type of wireless network. The network 1220 can use protocols and components for communicating via the Internet or any of the other aforementioned types of networks, such as HTTP, TCP/IP, and/or UDP/IP.

It is to be understood that not necessarily all objects or advantages may be achieved in accordance with any particular embodiment described herein. Certain embodiments may be configured to operate in a manner that achieves or optimizes one advantage or group of advantages as taught herein without necessarily achieving other objects or advantages as may be taught or suggested herein.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In some embodiments, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “might,” “may,” “e.g.,” “for example,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements or states are in any way required for one or more embodiments.

Disjunctive language such as the phrase “at least one of X, Y. or Z,” unless specifically stated otherwise, is otherwise understood with the context as used in general to present that an item, term, etc., may be either X, Y, or Z, or any combination thereof (e.g., X, Y, and/or Z). Such disjunctive language is not generally intended to, and should not, imply that certain embodiments require at least one of X, at least one of Y, and at least one of Z to each be present. Thus, the term “or” is used in its inclusive sense (and not in its exclusive sense) so that when used, for example, to connect a list of elements, the term “or” means one, some, or all of the elements in the list.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved.

The term “a” as used herein should be given an inclusive rather than exclusive interpretation. For example, unless specifically noted, the term “a” should not be understood to mean “exactly one” or “one and only one”; instead, the term “a” means “one or more” or “at least one.” whether used in the claims or elsewhere in the specification and regardless of uses of quantifiers such as “at least one,” “one or more,” or “a plurality” elsewhere in the claims or specification.

The terms “comprising,” “including,” “having,” and the like are synonymous and are used inclusively, in an open-ended fashion, and do not exclude additional elements, features, acts, operations, and so forth.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others.

1. A system for substantially real-time speech-to-text, text-to-text, text-to-speech, or speech-to-speech translation for multiple users, the system comprising:
a data storage medium; and
one or more computer hardware processors in communication with the data storage medium, wherein the one or more computer hardware processors are configured to execute computer-executable instructions to at least:
implement an application programming interface (API) service configured to receive a language translation request;
receive, via the API service, a first translation request from a first client computing device, the first translation request comprising audio data, the audio data comprising speech in a first source language;
transmit, via a first third-party API in a first programming language, a first third-party request comprising (i) a first source language indicator associated with the first source language, (ii) a first target language indicator, and (iii) the audio data;
receive, from the first third-party API, first text data in a first target language;
transmit, to the first client computing device, the first text data in the first target language;
receive, via the API service, a second translation request from a second client computing device, the second translation request comprising second text data in a second source language;
transmit, via a second third-party API in a second programming language, a second third-party request comprising (i) a second source language indicator associated with the second source language, (ii) a second target language indicator, and (iii) the second text data;
receive, from the second third-party API, third text data in a second target language associated with the second target language indicator; and
transmit, to the second client computing device, the third text data in the second target language.

2. The system of claim 1, wherein the one or more computer hardware processors are configured to execute further computer-executable instructions to at least:
determine that the first third-party API is configured to translate the first target language; and
select, from a plurality of third-party APIs, the first third-party API based at least in part on the first third-party API being configured to translate the first target language.

3. The system of claim 1, wherein the one or more computer hardware processors are configured to execute further computer-executable instructions to at least:
determine that another third-party API is unavailable; and
select, from among the first third-party API and the another third-party API, the first third-party API based at least in part on the another third-party API being unavailable.

4. The system of claim 1, wherein the one or more computer hardware processors are configured to execute further computer-executable instructions to at least:
confirm a persistent connection between the API service and the first client computing device, wherein the first translation request is received via the persistent connection; and
receive, via the persistent connection, a third translation request from the first client computing device.

5. The system of claim 1, wherein the one or more computer hardware processors are configured to execute further computer-executable instructions to at least:
implement a protocol buffer between the API service and a processing service;
in response to receiving the first translation request, substantially in real-time:
determine a command associated with the first translation request; and
transmit, via the protocol buffer, the command to the processing service,
wherein to transmit the first third-party request is substantially in real-time in response to receiving the first translation request.

6. The system of claim 1, wherein the API service comprises first computer-executable instructions programmed in a Rust programming language.

7. A system comprising:
a data storage medium; and
one or more computer hardware processors in communication with the data storage medium, wherein the one or more computer hardware processors are configured to execute computer-executable instructions to at least:
implement an application programming interface (API) service configured to receive a language translation request;
implement a protocol buffer between the API service and a processing service;
receive, via the API service, a first translation request from a first client computing device, the first translation request comprising audio data, the audio data comprising speech in a first source language;
in response to receiving the first translation request, substantially in real-time:
determine a first command associated with the first translation request;
transmit, via the protocol buffer, the first command to the processing service;
transmit, via a first third-party API, a first third-party request associated with the first command, the first third-party request comprising (i) a first source language indicator associated with the first source language, (ii) a first target language indicator, and (iii) the audio data;
receive, from the first third-party API, first text data in a first target language; and
transmit, to the first client computing device, the first text data in the first target language.

8. The system of claim 7, wherein the first third-party API is in a first programming language, and wherein the one or more computer hardware processors are configured to execute further computer-executable instructions to at least:
receive, via the API service, a second translation request from a second client computing device, the second translation request comprising second text data in a second source language;
in response to receiving the second translation request, substantially in real-time:
determine a second command associated with the second translation request;
transmit, via the protocol buffer, the second command to the processing service;
transmit, via a second third-party API in a second programming language, a second third-party request associated with the second command, the second third-party request comprising (i) a second source language indicator associated with the second source language, (ii) a second target language indicator, and (iii) the second text data;
receive, from the second third-party API, third text data in a second target language; and
transmit, to the second client computing device, the third text data in the second target language.

9. The system of claim 7, wherein the one or more computer hardware processors are configured to execute further computer-executable instructions to at least:
determine that the first third-party API is configured to translate the first target language; and
select, from a plurality of third-party APIs, the first third-party API based at least in part on the first third-party API being configured to translate the first target language.

10. The system of claim 9, wherein to determine that the first third-party API is configured to translate the first target language, the one or more computer hardware processors are configured to execute further computer-executable instructions to at least:
determine, via a configuration mapping, that the first third-party API supports translation of the first target language.

11. The system of claim 7, wherein the one or more computer hardware processors are configured to execute further computer-executable instructions to at least:
determine that another third-party API is unavailable; and
select, from among the first third-party API and the another third-party API, the first third-party API based at least in part on the another third-party API being unavailable.

12. The system of claim 7, wherein the one or more computer hardware processors are configured to execute further computer-executable instructions to at least:
determine a first latency associated with the first third-party API at a first region;
determine a second latency associated with the first third-party API at a second region; and
select, from among the first region and the second region, the first third-party API at the first region based at least in part on the first latency and the second latency,
wherein the first third-party request is transmitted to the first third-party API at the first region.

13. The system of claim 7, wherein the one or more computer hardware processors are configured to execute further computer-executable instructions to at least:
confirm a persistent connection between the API service and the first client computing device, wherein the first translation request is further received via the persistent connection, and wherein the first text data is transmitted via the persistent connection.

14. A method comprising:
implementing an application programming interface (API) service configured to receive a language translation request;
confirming a first persistent connection between the API service and a first client computing device;
receiving, via the first persistent connection, a first translation request from the first client computing device, the first translation request comprising first input data associated with a first source language;
in response to receiving the first translation request, substantially in real-time:
determining a first command associated with the first translation request;
transmitting the first command to a processing service;
transmitting, via a first third-party API, a first third-party request associated with the first command, the first third-party request comprising (i) a first source language indicator associated with the first source language, (ii) a first target language indicator, and (iii) the first input data;
receiving, from the first third-party API, first output data associated with a first target language; and
transmitting, via the first persistent connection, the first output data to the first client computing device.

15. The method of claim 14, wherein the first third-party API is in a first programming language, further comprising:
confirming a second persistent connection between the API service and a second client computing device;
receiving, via the second persistent connection, a second translation request from the second client computing device, the second translation request comprising second input data associated with a second source language;
in response to receiving the second translation request, substantially in real-time:
determining a second command associated with the second translation request;
transmitting the second command to the processing service;
transmitting, via a second third-party API in a second programming language, a second third-party request associated with the second command, the second third-party request comprising (i) a second source language indicator associated with the second source language, (ii) a second target language indicator, and (iii) the second input data;
receiving, from the second third-party API, second output data associated with a second target language; and
transmitting, via the second persistent connection, the second output data to the second client computing device.

16. The method of claim 14, further comprising:
determining that the first third-party API is configured to translate the first target language; and
selecting, from a plurality of third-party APIs, the first third-party API based at least in part on the first third-party API being configured to translate the first target language.

17. The method of claim 16, wherein determining that the first third-party API is configured to translate the first target language further comprises:
confirming, via a configuration mapping, that the first third-party API supports translation of the first target language.

18. The method of claim 14, further comprising:
implementing a protocol buffer between the API service and a processing service, wherein transmitting the first command to the processing service is via the protocol buffer.

19. The method of claim 14, further comprising:
determining that another third-party API is unavailable; and
selecting, from among the first third-party API and the another third-party API, the first third-party API based at least in part on the another third-party API being unavailable.

20. The method of claim 14, further comprising:
determining a first latency associated with the first third-party API at a first region;
determining a second latency associated with the first third-party API at a second region; and
selecting, from among the first region and the second region, the first third-party API at the first region based at least in part on the first latency and the second latency,
wherein the first third-party request is transmitted to the first third-party API at the first region.

21-36. (canceled)
